(19) United States
(12) Patent Application Publication
(10) Pub. No.: US 2025/0274857 A1
(43) Pub. Date: Aug. 28, 2025

(54) ELECTRONIC DEVICE AND METHOD FOR IDENTIFYING PRIORITY OF CONNECTION, AND NON-TRANSITORY COMPUTER-READABLE STORAGE MEDIUM

(71) Applicant: Samsung Electronics Co., Ltd., Suwon-si (KR)

(72) Inventors: Junwan CHO, Suwon-si (KR); Gupil CHEONG, Suwon-si (KR); Doosuk KANG, Suwon-si (KR)

(21) Appl. No.: 19/209,405

(22) Filed: May 15, 2025

Related U.S. Application Data
(63) Continuation of application No. PCT/KR2023/015471, filed on Oct. 6, 2023.

(30) Foreign Application Priority Data
Nov. 18, 2022 (KR) 10-2022-0155856
Jan. 20, 2023 (KR) 10-2023-0009092

(51) Int. Cl. H04W 52/02; H04R 1/10; H04W 4/80; H04W 76/14

(52) U.S. Cl. CPC H04W 52/02; H04R 1/10; H04W 4/80; H04W 76/14

(57) ABSTRACT

An electronic device may comprise: a housing; at least one communication circuit within the housing; a power management circuit within the housing configured to charge rechargeable batteries of one or more other electronic devices accommodated within a portion of the housing; and a control circuit within the housing. The control circuit may be configured to cause the electronic device to, while the one or more other electronic devices are accommodated within the housing, identify reception of an advertising signal broadcast from a first external electronic device and another advertising signal broadcast from a second external electronic device, and based on a reception strength of the advertising signal, being greater than a reception strength of the other advertising signal, transmit, to the one or more other electronic devices, a signal indicating a connection attempt between the first external electronic device and the one or more other electronic devices, which is to be executed prior to another connection attempt between the second electronic device and the one or more other electronic devices.

### CROSS-REFERENCE TO RELATED APPLICATIONS

This application is a continuation of International Application No. PCT/KR2023/015471 designating the United States, filed on Oct. 6, 2023, in the Korean Intellectual Property Receiving Office and claiming priority to Korean Patent Application Nos. 10-2022-0155856, filed on Nov. 18, 2022, and 10-2023-0009092, filed on Jan. 20, 2023, in the Korean Intellectual Property Office, the disclosures of each of which are incorporated by reference herein in their entireties.

### BACKGROUND

### Field

The disclosure relates to an electronic device, a method, and a non-transitory computer readable storage medium that identify a priority of a connection.

### Description of Related Art

Compared to legacy Bluetooth® (or classic Bluetooth), Bluetooth® low energy (BLE) may provide reduced power consumption and provide at least a similar or often greater communication range between connected devices. BLE may be provided on an industrial, scientific, and medical (ISM) radio band.

### SUMMARY

According to various example embodiments, an electronic device is provided. The electronic device may comprise: a housing; at least one communication circuit disposed in the housing; a power management circuit disposed in the housing, and configured to charge a rechargeable battery of one or more other electronic devices stored in a portion of the housing; control circuitry disposed in the housing, operably coupled with the at least one communication circuit and the power management circuit, wherein the control circuitry may be configured to cause the electronic device to: while the one or more other electronic devices are stored in the housing, identify receiving an advertising signal broadcast from a first external electronic device and another advertising signal broadcast from a second external electronic device; and based on a reception strength of the advertising signal being greater than a reception strength of the other advertising signal, transmit, to the one or more other electronic devices, a signal indicating an attempt of a connection between the first external electronic device and the one or more other electronic devices to be executed prior to an attempt of another connection between the second external electronic device and the one or more other electronic devices.

According to various example embodiments, a method is provided. The method may be executed in an electronic device comprising a housing, at least one communication circuit disposed in the housing, and a power management circuit disposed in the housing, and configured to charge a rechargeable battery of one or more other electronic devices stored in a portion of the housing. The method may comprise: while the one or more other electronic devices are stored in the housing, identifying receiving an advertising signal broadcast from a first external electronic device and another advertising signal broadcast from a second external electronic device; and based on a reception strength of the advertising signal being greater than a reception strength of the other advertising signal, transmitting, to the one or more other electronic devices, a signal indicating an attempt of a connection between the first external electronic device and the one or more other electronic devices to be executed prior to an attempt of another connection between the second external electronic device and the one or more other electronic devices.

According to various example embodiments, a non-transitory computer-readable storage medium is provided. The non-transitory computer readable storage medium may store one or more programs. The one or more programs may comprise instructions which, when executed by control circuitry of an electronic device comprising a housing, at least one communication circuit disposed in the housing, and a power management circuit disposed in the housing and configured to charge a rechargeable battery of one or more other electronic devices stored in a portion of the housing, cause the electronic device to: while the one or more other electronic devices are stored in the housing, identify receiving an advertising signal broadcast from a first external electronic device and another advertising signal broadcast from a second external electronic device; and based on a reception strength of the advertising signal being greater than a reception strength of the other advertising signal, transmit, to the one or more other electronic devices, a signal indicating an attempt of a connection between the first external electronic device and the one or more other electronic devices to be executed prior to an attempt of another connection between the second external electronic device and the one or more other electronic devices.

According to various example embodiments, an electronic device is provided. The electronic device may comprise: a housing; a first communication circuit disposed in the housing; a second communication circuit disposed in the housing; a power management circuit disposed in the housing, and configured to charge a rechargeable battery of one or more other electronic devices stored in a portion of the housing; and control circuitry disposed in the housing, wherein the control circuitry may be configured to cause the electronic device to: while the one or more other electronic devices are stored in the housing, identify, via the second communication circuit, a distance from the first external electronic device and a distance from the second external electronic device; and based on the distance from the second external electronic device being greater than the distance from the first external electronic device, transmit, to the one or more other electronic devices, via the power management circuit or the second communication circuit, a signal indicating an attempt of a connection between the first external electronic device and the one or more other electronic devices to be executed prior to an attempt of another connection between the second external electronic device and the one or more other electronic devices.

According to various example embodiments, a method is provided. The method may be executed in an electronic device comprising a housing, a first communication circuit disposed in the housing, a second communication circuit disposed in the housing, a power management circuit disposed in the housing, and configured to charge a rechargeable battery of one or more other electronic devices stored in a portion of the housing, and control circuitry disposed in the housing. The method may comprise: while the one or more other electronic devices are stored in the housing, identifying, via the second communication circuit, a distance from the first external electronic device and a distance from the second external electronic device; and based on the distance from the second external electronic device being greater than the distance from the first external electronic device, transmitting, to the one or more other electronic devices, via the power management circuit or the second communication circuit, a signal indicating an attempt of a connection between the first external electronic device and the one or more other electronic devices to be executed prior to an attempt of another connection between the second external electronic device and the one or more other electronic devices.

According to various example embodiments, a non-transitory computer readable storage medium is provided. The non-transitory computer readable storage medium may store one or more programs. The one or more programs may comprise instructions which, when executed by control circuitry of an electronic device comprising a housing, a first communication circuit disposed in the housing, a second communication circuit disposed in the housing, and a power management circuit disposed in the housing, and configured to charge a rechargeable battery of one or more other electronic devices stored in a portion of the housing, cause the electronic device to: while the one or more other electronic devices are stored in the housing, identify, via the second communication circuit, a distance from the first external electronic device and a distance from the second external electronic device; and based on the distance from the second external electronic device being greater than the distance from the first external electronic device, transmit, to the one or more other electronic devices, via the power management circuit or the second communication circuit, a signal indicating an attempt of a connection between the first external electronic device and the one or more other electronic devices to be executed prior to an attempt of another connection between the second external electronic device and the one or more other electronic devices.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of an environment including an electronic device, one or more other electronic devices, a first external electronic device, and a second external electronic device according to various embodiments;

FIG. 2 is a block diagram illustrating an example configuration of an electronic device according to various embodiments;

FIG. 3 is a flowchart illustrating an example method of identifying a priority of a connection between a first external electronic device and one or more other electronic devices and another priority of another connection between a second external electronic device and one or more other electronic devices according to various embodiments;

FIG. 4 is a flowchart illustrating an example method of transmitting a signal based on an advertising signal and another advertising signal according to various embodiments;

FIG. 5 is a diagram illustrating an example of a state of each of a first external electronic device and a second external electronic device according to various embodiments;

FIG. 6 is a signal flow diagram illustrating an example method of changing a state of control circuitry based on an address according to various embodiments;

FIG. 7 is a flowchart illustrating an example method of changing execution of a scanning based on a first cycle to execution of a scanning based on a second cycle according to various embodiments;

FIG. 8 is a diagram illustrating an example of a predefined or specified event according to various embodiments;

FIG. 9 is a flowchart illustrating an example method of transmitting a signal by adjusting a priority of a connection and another priority of another connection based on a reception strength of an advertising signal and a reception strength of another advertising signal according to various embodiments;

FIG. 10 is a flowchart illustrating an example method of transmitting a signal in response to a predefined or specified event according to various embodiments;

FIG. 11 is a flowchart illustrating an example method of transmitting a signal based on a distance from a first external electronic device and a distance from a second external electronic device according to various embodiments;

FIG. 12 is a flowchart illustrating an example method of transmitting a signal by adjusting a priority of a connection and another priority of another connection based on a distance from a first external electronic device and a distance from a second external electronic device according to various embodiments;

FIG. 13 is a signal flow diagram illustrating an example method of identifying a distance from a first external electronic device according to various embodiments; and

FIG. 14 is a block diagram illustrating an example electronic device in a network environment according to various embodiments.

### DETAILED DESCRIPTION

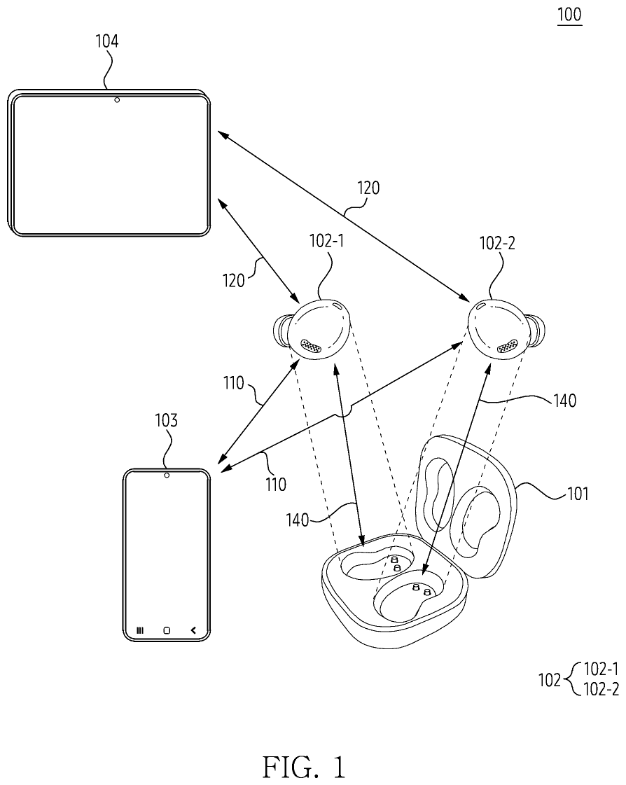

FIG. 1 is a diagram illustrating an example of an environment including an electronic device, one or more other electronic devices, a first external electronic device, and a second external electronic device according to various embodiments.

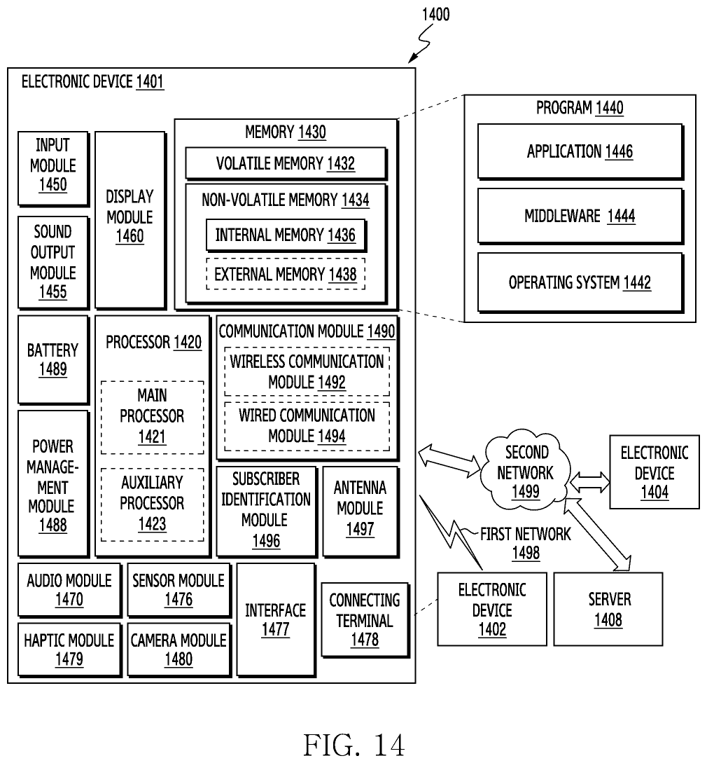

Referring to FIG. 1, an environment 100 may include an electronic device 101, one or more other electronic devices 102, a first external electronic device 103, and a second external electronic device 104. For example, each of the electronic device 101 and the one or more other electronic devices 102 may include at least a portion of the electronic device 1402 of FIG. 14. For example, the one or more other electronic devices 102 may include a first other electronic device 102-1 and a second other electronic device 102-2. For example, each of the first external electronic device 103 and the second external electronic device 104 may include at least a portion of the electronic device 1401 of FIG. 14.

The electronic device 101 in the environment 100 may include a device for providing power to each of the one or more other electronic devices 102. The electronic device 101 may provide a space for storing each of the one or more other electronic devices 102. For example, the electronic device 101 may provide a first state in which at least a portion of each of the one or more other electronic devices 102 stored in the space is exposed (e.g., a case or housing of the electronic device 101 is opened). For example, the electronic device 101 may provide a second state in which each of the one or more other electronic devices 102 stored in the space is covered (e.g., a case or housing of the electronic device 101 is closed). For example, the electronic device 101 may provide a third state in which each of the one or more other electronic devices 102 is spaced apart from the space. However, the disclosure is not limited thereto. For example, the electronic device 101 may be referred to as a cradle.

The one or more other electronic devices 102 in the environment 100 may include, for example, audio sink devices, such as earbuds or earphones. For example, the one or more other electronic devices 102 may be configured as a pair. However, the disclosure is not limited thereto.

For example, each of the one or more other electronic devices 102 may receive data on audio from the first external electronic device 103 (or the second external electronic device 104) and output the audio via a speaker of each of the one or more other electronic devices 102 based on the data. For example, each of the one or more other electronic devices 102 may receive a request from the first external electronic device 103 (or the second external electronic device 104) and respectively transmit, to the first external electronic device 103 (or the second external electronic device 104), data on audio respectively obtained via a microphone of each of the one or more other electronic devices 102, in response to the request. For example, the data may be usable for playing the audio within the first external electronic device 103 (or the second external electronic device 104). For example, each of the one or more other electronic devices 102 may be referred to as a peripheral device, a secondary device, or a sub device.

For example, each of the one or more other electronic devices 102 may be stored in the electronic device 101. For example, each of the one or more other electronic devices 102 may include a rechargeable battery. For example, each of the one or more other electronic devices 102 may obtain power for charging a battery from the electronic device 101. For example, while each of the one or more other electronic devices 102 is stored in the electronic device 101, each of the one or more other electronic devices 102 may obtain the power from the electronic device 101.

Each of the first external electronic device 103 and the second external electronic device 104 in the environment 100 may be an audio source device such as a smartphone, a laptop computer, a desktop computer, or a tablet PC. For example, each of the first external electronic device 103 and the second external electronic device 104 may transmit, to each of the one or more other electronic devices 102, data on audio being played in each of the first external electronic device 103 and the second external electronic device 104. For example, the data may be usable in each of the one or more other electronic devices 102 to output the audio from each of the one or more other electronic devices 102. For example, each of the first external electronic device 103 and the second external electronic device 104 may be referred to as a central device, a primary device, or a main device.

For example, in order to provide an audio service, each of the one or more other electronic devices 102 and the first external electronic device 103 may establish a connection 110 between each of the one or more other electronic devices 102 and the first external electronic device 103. For example, in order to provide the audio service, each of the one or more other electronic devices 102 and the second external electronic device 104 may establish a connection 120 between each of the one or more other electronic devices 102 and the second external electronic device 104.

For example, the first external electronic device 103 and the second external electronic device 104 may be located around the electronic device 101 and the one or more other electronic devices 102. For example, the one or more other electronic devices 102 stored in the electronic device 101 may be in a state connectable with both the first external electronic device 103 and the second external electronic device 104. For example, the one or more other electronic devices 102 may execute operations for establishing a connection from among the connection 110 and the connection 120, in response to identifying a change of the electronic device 101 from the second state to the first state.

As a non-limiting example, a user may change a state of the electronic device 101 from the second state to the first state, in order to play audio to be output via the one or more other electronic devices 102 using the first external electronic device 103 from among the first external electronic device 103 and the second external electronic device 104 located around the electronic device 101. For example, since the user's intention is to establish the connection 110 for outputting the audio, the one or more other electronic devices 102 establishing the connection 120 prior to the connection 110 in response to the change from the second state to the first state may cause inconvenience.

As a non-limiting example, a user may change a state of the electronic device 101 from the second state to the first state, in order to play audio to be output via the one or more other electronic devices 102 using the second external electronic device 104 from among the first external electronic device 103 and the second external electronic device 104 located around the electronic device 101. For example, since the user's intention is to establish the connection 120 for outputting the audio, the one or more other electronic devices 102 establishing the connection 110 prior to the connection 120 in response to the change from the second state to the first state may cause inconvenience.

For example, in order to reduce this inconvenience, the electronic device 101 may identify a priority of the connection 110 between the one or more other electronic devices 102 and the first external electronic device 103, and a priority of the connection 120 between the one or more other electronic devices 102 and the second external electronic device 104. For example, in order to identify the priority of the connection 110 and the priority of the connection 120, the electronic device 101 may identify a distance from the first external electronic device 103 to the electronic device 101 and a distance from the second external electronic device 104 to the electronic device 101. As a non-limiting example, since an external electronic device closer to the electronic device 101 from among the first external electronic device 103 and the second external electronic device 104 may be relatively more likely to be a device for playing audio, the electronic device 101 may identify the distance from the first external electronic device 103 to the electronic device 101 and the distance from the second external electronic device 104 to the electronic device 101.

For example, a connection 140 between the electronic device 101 and the one or more other electronic devices 102 may be used to transmit, from the electronic device 101 to the one or more other electronic devices 102, a signal indicating the priority of connection 110 and the priority of connection 120. As a non-limiting example, the connection 140 may be provided based on a Bluetooth low energy (BLE) communication technique. As a non-limiting example, the connection 140 may be provided based on a power line communication (PLC) technique executed via a connector (e.g., pogo pin) of the electronic device 101 for electrically coupling the electronic device 101 and the one or more other electronic devices 102.

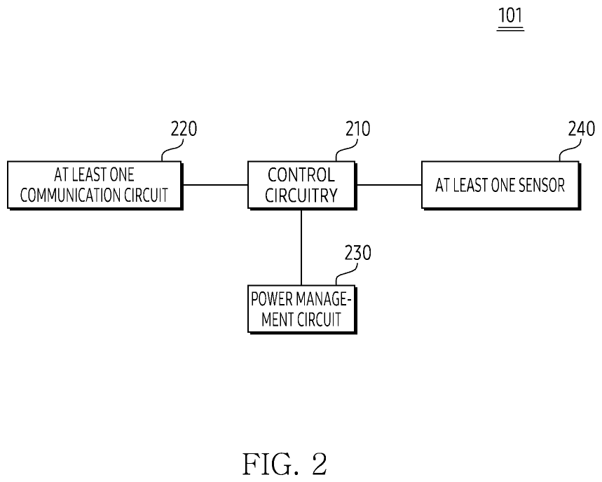

For example, the electronic device 101 may include components for executing the above-described operations. The components may be illustrated and described in greater detail below with reference to FIG. 2.

FIG. 2 is a block diagram illustrating an example configuration of an electronic device according to various embodiments.

Referring to FIG. 2, an electronic device 101 may include control circuitry 210, at least one communication circuit 220, and a power management circuit 230. For example, the electronic device 101 may further include at least one sensor 240.

For example, the control circuitry 210 may be configured to execute at least a portion of operations to be illustrated and described in greater detail below. For example, the control circuitry 210 may be operably coupled with each of the at least one communication circuit 220, the power management circuit 230, and the at least one sensor 240.

For example, the control circuitry 210 being operably coupled with each of the at least one communication circuit 220, the power management circuit 230, and the at least one sensor 240 may indicate that the control circuitry 210 is directly connected with each of the at least one communication circuit 220, the power management circuit 230, and the at least one sensor 240. For example, the control circuitry 210 being operably coupled with each of the at least one communication circuit 220, the power management circuit 230, and the at least one sensor 240 may indicate that the control circuitry 210 is connected, via another component of the electronic device 101, to each of the at least one communication circuit 220, the power management circuit 230, and the at least one sensor 240. For example, the control circuitry 210 being operably coupled with each of the at least one communication circuit 220, the power management circuit 230, and the at least one sensor 240 may indicate that each of the at least one communication circuit 220, the power management circuit 230, and the at least one sensor 240 operates based on instructions executed by the control circuitry 210. For example, the control circuitry 210 being operably coupled with each of the at least one communication circuit 220, the power management circuit 230, and the at least one sensor 240 may indicate that each of the at least one communication circuit 220, the power management circuit 230, and the at least one sensor 240 is controlled by the control circuitry 210. However, the disclosure is not limited thereto.

For example, the at least one communication circuit 220 may be configured to execute at least a portion of operations to be illustrated and described in greater detail below. For example, the at least one communication circuit 220 may be used to receive, from the one or more other electronic devices 102, information, data, and/or a signal. For example, the at least one communication circuit 220 may be used to transmit, to the one or more other electronic devices 102, information, data, and/or a signal. For example, the at least one communication circuit 220 may be used to receive, from the first external electronic device 103, information, data, and/or a signal. For example, the at least one communication circuit 220 may be used to receive, from the second external electronic device 104, information, data, and/or a signal. As a non-limiting example, the at least one communication circuit 220 may include a first communication circuit for a BLE communication technique and a second communication circuit for a UWB communication technique.

For example, the power management circuit 230 may be used to charge a rechargeable battery of the one or more other electronic devices 102 stored in a housing of the electronic device 101. For example, the power management circuit 230 may be used to transmit, to the one or more other electronic devices 102 via a connector of the electronic device 101 for electrically coupling the electronic device 101 with the one or more other electronic devices 102 stored in the housing of the electronic device 101, information, data, and/or a signal. For example, the power management circuit 230 may be used to receive, from the one or more other electronic devices 102 via a connector of the electronic device 101 for electrically coupling the electronic device 101 with the one or more other electronic devices 102 stored in the housing of the electronic device 101, information, data, and/or a signal.

For example, the at least one sensor 240 may be used to identify a state of the electronic device 101 and/or a state around the electronic device 101. For example, the at least one sensor 240 may be used to identify a user input and/or a predefined event. As a non-limiting example, data obtained via the at least one sensor 240 may be provided to the control circuitry 210, the at least one communication circuit 220, and/or the power management circuit 230.

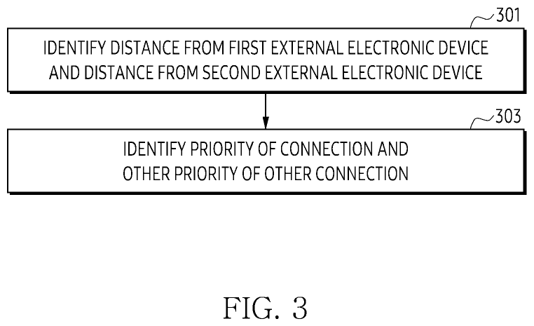

For example, the control circuitry 210 may identify a priority of a connection (e.g., the connection 110) between the first external electronic device 103 and the one or more other electronic devices 102 and a priority of another connection (e.g., the connection 120) between the second external electronic device 104 and the one or more other electronic devices 102. The identification may be illustrated and described in greater detail below with reference to FIG. 3.

FIG. 3 is a flowchart illustrating an example method of identifying a priority of a connection between a first external electronic device and one or more other electronic devices and another priority of another connection between a second external electronic device and one or more other electronic devices according to various embodiments.

Referring to FIG. 3, in operation 301, the control circuitry 210 may identify a distance from the first external electronic device 103 and a distance from the second external electronic device 104 to the electronic device 101. For example, in the second state illustrated in FIG. 1, the control circuitry 210 may respectively identify the distance between the electronic device 101 and the first external electronic device 103 and the distance between the electronic device 101 and the second external electronic device 104. For example, while the one or more other electronic devices 102 are stored in a housing of the electronic device 101, the control circuitry 210 may respectively identify the distance between the electronic device 101 and the first external electronic device 103 and the distance between the electronic device 101 and the second external electronic device 104.

For example, identifying the distance between the electronic device 101 and the first external electronic device 103 and the distance between the electronic device 101 and the second external electronic device 104 may be executed, in the second state, while the first external electronic device 103 and/or the second external electronic device 104 are located around the electronic device 101. For example, the first external electronic device 103 and/or the second external electronic device 104 being located around the electronic device 101 may indicate a state in which a signal transmitted from the first external electronic device 103 and/or a signal transmitted from the second external electronic device 104 may respectively reach the electronic device 101. For example, the first external electronic device 103 and/or the second external electronic device 104 being located around (e.g., within a threshold distance) the electronic device 101 may indicate a state in which a signal transmitted from the electronic device 101 may reach the first external electronic device 103 and/or the second external electronic device 104. For example, the first external electronic device 103 and/or the second external electronic device 104 being located around the electronic device 101 may indicate that the electronic device 101 and the second external electronic device 104 are located within a coverage of the first external electronic device 103. For example, the first external electronic device 103 and/or the second external electronic device 104 being located around the electronic device 101 may indicate that the electronic device 101 and/or the first external electronic device 103 is located within a coverage of the second external electronic device 104. For example, the first external electronic device 103 and/or the second external electronic device 104 being located around the electronic device 101 may indicate that the first external electronic device 103 and/or the second external electronic device 104 is located within a coverage of the electronic device 101. However, the disclosure is not limited thereto.

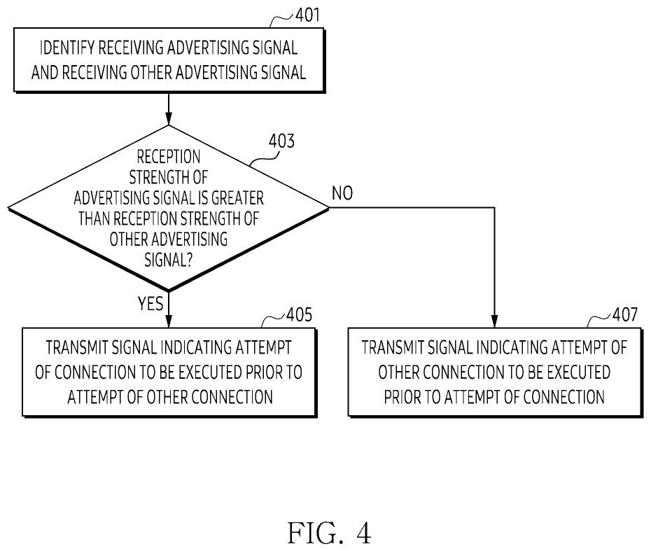

A method of identifying the distance from the first external electronic device 103 and the distance from the second external electronic device 104 will be illustrated and described in greater detail below with reference to FIGS. 4, 6, 9, 11, 12, and 13.

In operation 303, the control circuitry 210 may identify a priority of a connection (e.g., the connection 110) between the first external electronic device 103 and the one or more other electronic devices 102 and a priority of another connection (e.g., the connection 120) between the second external electronic device 104 and the one or more other electronic devices 102, based on the distance from the first external electronic device 103 and the distance from the second external electronic device 104.

For example, the control circuitry 210 may identify the priority of the connection higher than the other priority of the other connection, based on the distance from the first external electronic device 103 being less than the distance from the second external electronic device 104. For example, the distance from the first external electronic device 103 being less than the distance from the second external electronic device 104 may indicate that the distance from the first external electronic device 103 is less than the distance from the second external electronic device 104 and that a difference value between the distance from the first external electronic device 103 and the distance from the second external electronic device 104 is greater than or equal to a reference value. However, the disclosure is not limited thereto. For example, the priority of the connection being higher than the other priority of the other connection may indicate that an attempt of the connection is executed prior to an attempt of other connection. For example, the attempt of the connection may indicate executing operations for establishing the connection.

For example, the control circuitry 210 may identify the priority of the connection lower than the other priority of the other connection, based on the distance from the first external electronic device 103 being greater than the distance from the second external electronic device 104. For example, the distance from the first external electronic device 103 being greater than the distance from the second external electronic device 104 may indicate that the distance from the first external electronic device 103 is greater than the distance from the second external electronic device 104 and that a difference value between the distance from the first external electronic device 103 and the distance from the second external electronic device 104 is greater than or equal to the reference value. However, the disclosure is not limited thereto. For example, the priority of the connection being lower than the other priority of the other connection may indicate that an attempt of the other connection is executed prior to the attempt of the connection.

For example, the control circuitry 210 may identify data indicating a history of the connection and a history of the other connection based on the distance from the first external electronic device 103 corresponding to the distance from the second external electronic device 104 and identify the priority of the connection and the other priority of the other connection based on the identified data. For example, the data may include information indicating a time at which the connection was most recently established (and/or a time at which the connection was most recently disconnected) and a time at which the other connection was most recently established (and/or a time at which the other connection was most recently disconnected).

For example, the data may be obtained from the one or more other electronic devices 102 stored in the housing of the electronic device 101 before operation 301 is executed or before the execution of operation 301 is completed. For example, the data may be obtained via a connection (e.g., the connection 140) between the electronic device 101 and the one or more other electronic devices 102.

For example, the data may indicate an external electronic device most recently connected with the one or more other electronic devices 102 from among the first external electronic device 103 and the second external electronic device 104. For example, when the first external electronic device 103 among the first external electronic device 103 and the second external electronic device 104 is most recently connected with the one or more other electronic devices 102, the priority of the connection indicated by the data may be higher than the other priority of the other connection indicated by the data. For example, when the second external electronic device 104 among the first external electronic device 103 and the second external electronic device 104 is most recently connected with the one or more other electronic devices 102, the priority of the connection indicated by the data may be lower than the other priority of the other connection indicated by the data.

For example, the data may indicate an external electronic device most frequently connected with the one or more other electronic devices 102 from among the first external electronic device 103 and the second external electronic device 104. For example, when the first external electronic device 103 among the first external electronic device 103 and the second external electronic device 104 is most frequently connected with the one or more other electronic devices 102, the priority of the connection indicated by the data may be higher than the other priority of the other connection indicated by the data. For example, when the second external electronic device 104 among the first external electronic device 103 and the second external electronic device 104 is most frequently connected with the one or more other electronic devices 102, the priority of the connection indicated by the data may be lower than the other priority of the other connection indicated by the data.

For example, the distance from the first external electronic device 103 corresponding to the distance from the second external electronic device 104 may indicate that the distance from the first external electronic device 103 is equal to the distance from the second external electronic device 104. The distance from the first external electronic device 103 corresponding to the distance from the second external electronic device 104 may indicate that the distance from the first external electronic device 103 is greater or less than the distance from the second external electronic device 104, and a difference value between the distance from the first external electronic device 103 and the distance from the second external electronic device 104 is less than the reference value. However, the disclosure is not limited thereto.

For example, the control circuitry 210 may transmit, to the one or more other electronic devices 102 via the at least one communication circuit 220 or the power management circuit 230, a signals indicating the priority of the connection and the other priority of the other connection. For example, the signal may be transmitted to the one or more other electronic devices 102 via the connection (e.g., the connection 140) between the electronic device 101 and the one or more other electronic devices 102.

For example, the signal may have various formats.

For example, the signal, which indicates an attempt of the connection to be executed prior to an attempt of the other connection, may indicate the priority of the connection and the other priority of the other connection. For example, the signal, which indicates an attempt of the other connection to be executed prior to an attempt of the connection, may indicate the priority of the connection and the other priority of the other connection.

For example, when the priority of the connection is higher than the other priority of the other connection, the signal may indicate the priority of the connection and the other priority of the other connection by including an address of the first external electronic device 103 among the first external electronic device 103 and the second external electronic device 104. For example, when the priority of the connection is lower than the other priority of the other connection, the signal may indicate the priority of the connection and the other priority of the other connection by including an address of the second external electronic device 104 among the first external electronic device 103 and the second external electronic device 104.

For example, the signal may indicate the priority of the connection and the other priority of the other connection, by including data including a priority of the connection associated with the address of the first external electronic device 103 and another priority of the other connection associated with the address of the second external electronic device 104.

Although not illustrated in FIG. 3, when a portion of the one or more other electronic devices 102 is located outside the electronic device 101, another portion (or remaining portion) of the one or more other electronic devices 102 is located inside the electronic device 101, and the portion of the one or more other electronic devices 102 is connected with the first external electronic device 103 (or the second external electronic device 104) while the other portion of the one or more other electronic devices 102 is located inside the electronic device 101, the control circuitry 210 may transmit, to the other portion of the one or more other electronic devices 102, the signal indicating the priority of the connection (or the other priority of the other connection) higher than the other priority of the other connection (or the priority of the connection), independently (or regardless) of the distance from the first external electronic device 103 and the distance from the second external electronic device 104. For example, the control circuitry 210 may transmit, to the other portion of the one or more other electronic devices 102, the signal, such that the other portion of the one or more other electronic devices 102 is connected with the first external electronic device 103 (or the second external electronic device 104) connected with the portion of the one or more other electronic devices 102. However, the disclosure is not limited thereto. For example, when the portion of the one or more other electronic devices 102 is connected with the first external electronic device 103 (or the second external electronic device 104), the control circuitry 210 may bypass or refrain from executing operations 301 and 303. For another example, unlike the other portion of the one or more other electronic devices 102, when the portion of the one or more other electronic devices 102 is connected with the first external electronic device 103 (or the second external electronic device 104), the control circuitry 210 may transmit, to the other portion of the one or more other electronic devices 102, a signal obtained or identified according to operations 301 and 303. For example, even when the signal received from the electronic device 101 indicates the other priority of the other connection higher than the priority of the connections, the other portion of the one or more other electronic devices 102 may establish a connection between the first external electronic device 103 and the other portion of the one or more other electronic devices 102, based on a signal from the portion of the one or more other electronic devices 102 (e.g., a signal indicating that a connection between the first external electronic device 103 and the portion of the one or more other electronic devices 102 is established).

As described above, the electronic device 101 may identify, based on the distance from the first external electronic device 103 and the distance from the second external electronic device 104, the priority of the connection and the other priority of the other connection, and then share, with the one or more other electronic devices 102, the priority of the connection and the other priority of the other connection, such that the one or more other electronic devices 102 may attempt to connect firstly with an external electronic device among the first external electronic device 103 and the second external electronic device 104. For example, the electronic device 101 may enhance, via these operations, usability of the one or more other electronic devices 102.

Referring back to FIG. 2, the control circuitry 210 may execute operation 301 based on an advertising signal broadcast from the first external electronic device 103 and another advertising signal broadcast from the second external electronic device 104. For example, the control circuitry 210 may execute operation 301 using the first communication circuit. This execution may be illustrated and described in greater detail below with reference to FIG. 4.

FIG. 4 is a flowchart illustrating an example method of transmitting a signal based on an advertising signal and another advertising signal according to various embodiments.

Referring to FIG. 4, in operation 401, the control circuitry 210 may identify, via the at least one communication circuit 220, receiving the advertising signal broadcast from the first external electronic device 103 and the other advertising signal broadcast from the second external electronic device 104, while the one or more other electronic devices 102 are stored in a housing of the electronic device 101. For example, the control circuitry 210 may receive the advertising signal and the other advertising signal, in the second state. For example, identifying receiving the advertising signal and the other advertising signal may indicate that the at least one communication circuit 220 receives the advertising signal and the other advertising signal while the control circuitry 210 is in a sleep state or a low power state, and the control circuitry 210 in a wake-up state changed from the sleep state (or the low power state) after the advertising signal and the other advertising signal are received identifies the reception of the advertising signal and the reception of the other advertising signal. However, the disclosure is not limited thereto. For example, the control circuitry 210 may receive, via the at least one communication circuit 220, the advertising signal and the other advertising signal, in the wake-up state. For example, the sleep state may indicate a state in which a driving frequency of the control circuitry 210 is lower than a driving frequency of the control circuitry 210 used in the wake-up state. However, the disclosure is not limited thereto. For example, the low power state may indicate a state in which a power provided from the power management circuit 230 to the control circuitry 210 is less than a reference power, or a state in which the control circuitry 210 deactivates at least some functions of the electronic device 101. However, the disclosure is not limited thereto. For example, the wake-up state may indicate a state in which the driving frequency of the control circuitry 210 is higher than the driving frequency of the control circuitry 210 used in the sleep state. For example, the wake-up state may indicate a state in which a power provided by the control circuitry 210 from the power management circuit 230 is greater than or equal to the reference power. However, the disclosure is not limited thereto.

In operation 403, the control circuitry 210 may identify whether a reception strength of the advertising signal is greater than a reception strength of the other advertising signal. For example, a reception strength of each of the advertising signal and the other advertising signal may be indicated via a received signal strength indicator (RSSI). For example, the reception strength of each of the advertising signal and the other advertising signal may be indicated via a difference between a transmission power of each of the advertising signal and the other advertising signal and a reception power of each of the advertising signal and the other advertising signal. For example, when the reception strength is indicated via the difference, data on the transmission power of each of the advertising signal and the other advertising signal may be included in each of the advertising signal and the other advertising signal. However, the disclosure is not limited thereto.

For example, the control circuitry 210 may execute operation 405 based on the reception strength of the advertising signal being greater than the reception strength of the other advertising signal, and may execute operation 407 based on the reception strength of the advertising signal being less than the reception strength of the other advertising signal.

In operation 405, on a condition that the reception strength of the advertising signal is greater than the reception strength of the other advertising signal, the control circuitry 210 may transmit a signal indicating an attempt of a connection (e.g., the connection 110) between the one or more other electronic devices 102 and the first external electronic device 103 to be executed prior to an attempt of another connection (e.g., the connection 120) between the one or more other electronic devices 102 and the second external electronic device 104. For example, the signal may be the signal illustrated in greater detail with reference to FIG. 3. For example, the signal may include a first value associated with an address of the first external electronic device 103 and a second value associated with an address of the second external electronic device 104, and the first value may indicate that the priority of the connection is higher than the other priority of the other connection indicated by the second value. However, the disclosure is not limited thereto. For example, the signal may be transmitted via the connection (e.g., the connection 140) between the one or more other electronic devices 102 and the electronic device 101. For example, the signal may be transmitted via the at least one communication circuit 220 (or the first communication circuit). For example, the signal may be transmitted via the power management circuit 230. However, the disclosure is not limited thereto.

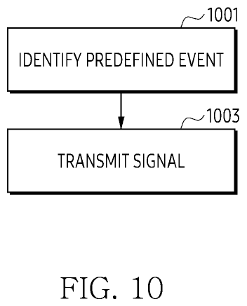

For example, a timing of a transmission of the signal may be set variously. For example, the signal may be transmitted immediately after identifying the reception strength of the advertising signal greater than the reception strength of the other advertising signal. For example, the signal may be transmitted, in response to identifying the reception strength of the advertising signal greater than the reception strength of the other advertising signal. For example, the signal may be transmitted in response to identifying a predefined event. For example, the predefined (e.g., specified) event will be illustrated and described in greater detail below with reference to FIG. 10. However, the disclosure is not limited thereto.

For example, the reception strength of the advertising signal being greater than the reception strength of the other advertising signal may indicate that the reception strength of the advertising signal is greater than the reception strength of the other advertising signal, and that a difference value between the reception strength of the advertising signal and the reception strength of the other advertising signal is greater than or equal to a reference value. However, the disclosure is not limited thereto.

Although not illustrated in FIG. 4, the one or more other electronic devices 102 may receive the signal from the electronic device 101. For example, the one or more other electronic devices 102 may execute, based on the signal, operations for establishing the connection prior to operations for establishing the other connection. For example, the operations for establishing the connection may be executed in response to the one or more other electronic devices 102 identifying that a state of the electronic device 101 is changed from the second state to the first state. As a non-limiting example, the control circuitry 210 may identify the change from the second state to the first state using a sensor for identifying a state of the case (or the housing) or a switch. As a non-limiting example, the control circuitry 210 may identify the change from the second state to the first state, based on receiving information indicating the state of the case from the one or more other electronic devices 102. For example, the operations for establishing the other connection may be executed in response to identifying that establishing the connection has failed.

In operation 407, on a condition that the reception strength of the advertising signal is less than the reception strength of the other advertising signal, the control circuitry 210 may transmit, to the one or more other electronic devices 102 via the at least one communication circuit 220 or the power management circuit 230, the signal indicating the attempt of the other connection to be executed prior to the attempt of the connection. For example, the signal may include a first value associated with an address of the second external electronic device 104 and a second value associated with an address of the first external electronic device 103, and the first value may indicate that the other priority of the other connection is higher than the priority of the connection indicated by the second value. However, the disclosure is not limited thereto. For example, the signal may be transmitted via the connection (e.g., the connection 140) between the one or more other electronic devices 102 and the electronic device 101. For example, the signal may be transmitted via the at least one communication circuit 220 (or the first communication circuit). For example, the signal may be transmitted via the power management circuit 230. However, the disclosure is not limited thereto.

For example, a timing of a transmission of the signal may be set variously. For example, the signal may be transmitted immediately after identifying the reception strength of the advertising signal less than the reception strength of the other advertising signal. For example, the signal may be transmitted in response to identifying the reception strength of the advertising signal less than the reception strength of the other advertising signal. For example, the signal may be transmitted in response to identifying a predefined event. For example, the predefined event will be illustrated and described in greater detail below with reference to FIG. 10. However, the disclosure is not limited thereto.

For example, the reception strength of the other advertising signal being greater than the reception strength of the advertising signal may indicate that the reception strength of the other advertising signal is greater than the reception strength of the advertising signal, and that a difference value between the reception strength of the advertising signal and the reception strength of the other advertising signal is greater than or equal to a reference value. However, the disclosure is not limited thereto.

Although not illustrated in FIG. 4, the one or more other electronic devices 102 may receive the signal from the electronic device 101. For example, the one or more other electronic devices 102 may, based on the signal, execute operations for establishing the other connection prior to operations for establishing the connection. For example, the operations for establishing the other connection may be executed in response to the one or more other electronic devices 102 identifying that a state of the electronic device 101 is changed from the second state to the first state. For example, the operations for establishing the connection may be executed in response to identifying that establishing the other connection has failed.

Although not illustrated in FIG. 4, the control circuitry 210 may identify, based on the reception strength of the advertising signal corresponding to the reception strength of the other advertising signal, data indicating a history of the connection and a history of the other connection, and transmit, based on the identified data, to the one or more other electronic devices 102 via the at least one communication circuit 220 or the power management circuit 230), the signal indicating the attempt of the connection to be executed prior to the attempt of the other connection or the signal indicating the attempt of the other connection to be executed prior to the attempt of the connection. For example, the data may be obtained from the one or more other electronic devices 102 stored in the housing of the electronic device 101, before operation 401 is executed or before the execution of operation 401 is completed. For example, the data may be obtained via a connection (e.g., the connection 140) between the electronic device 101 and the one or more other electronic devices 102.

For example, the reception strength of the advertising signal corresponding to the reception strength of the other advertising signal may indicate that the reception strength of the advertising signal is equal to the reception strength of the other advertising signal. The reception strength of the advertising signal corresponding to the reception strength of the other advertising signal may also indicate that the reception strength of the advertising signal is greater than or less than the reception strength of the other advertising signal, and that a difference value between the reception strength of the advertising signal and the reception strength of the other advertising signal is less than the reference value. However, the disclosure is not limited thereto.

For example, the data used when the reception strength of the advertising signal corresponds to the reception strength of the other advertising signal may indicate an external electronic device most recently connected with the one or more other electronic devices 102 from among the first external electronic device 103 and the second external electronic device 104. For example, when the first external electronic device 103 among the first external electronic device 103 and the second external electronic device 104 is most recently connected with the one or more other electronic devices 102, the signal may indicate, based on the data, the attempt of the connection to be executed prior to the attempt of the other connection. For example, when the second external electronic device 104 among the first external electronic device 103 and the second external electronic device 104 is most recently connected with the one or more other electronic devices 102, the signal may indicate, based on the data, the attempt of the other connection to be executed prior to the attempt of the connection.

For example, the data may indicate an external electronic device most frequently connected with the one or more other electronic devices 102 from among the first external electronic device 103 and the second external electronic device 104. For example, when the first external electronic device 103 among the first external electronic device 103 and the second external electronic device 104 is most frequently connected with the one or more other electronic devices 102, the signal may indicate, based on the data, the attempt of the connection to be executed prior to the attempt of the other connection. For example, when the second external electronic device 104 among the first external electronic device 103 and the second external electronic device 104 is most frequently connected with the one or more other electronic devices 102, the signal may indicate, based on the data, the attempt of the other connection to be executed prior to the attempt of the connection.

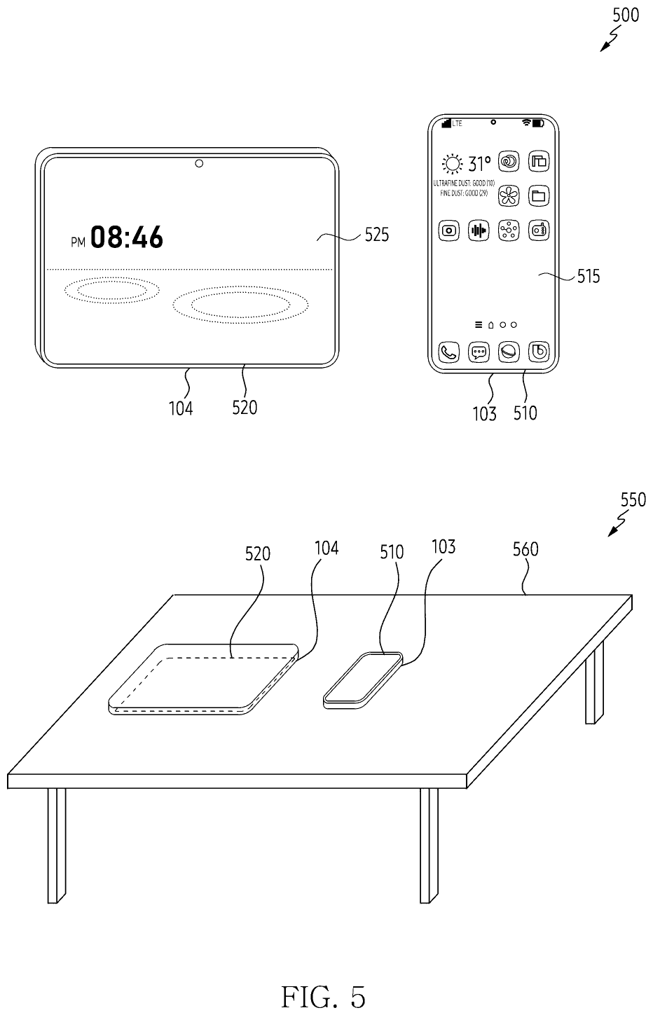

Although not illustrated in FIG. 4, a state of each of the first external electronic device 103 and the second external electronic device 104 may be further used to obtain the signal. For example, a state of the first external electronic device 103 may include a first state in which the first external electronic device 103 is available to play audio, and a second state in which the first external electronic device 103 is not available to play audio. For example, the first state of the first external electronic device 103 may indicate that a probability that the first external electronic device 103 will be used to play audio is higher than a probability that the first external electronic device 103 will not be used to play audio, and the second state of the first external electronic device 103 may indicate that the probability that the first external electronic device 103 will be used to play audio is lower than or equal to the probability that the first external electronic device 103 will not be used to play audio. However, the disclosure is not limited thereto. The first state of the first external electronic device 103 will be illustrated and described in greater detail below with reference to FIG. 5.

For example, a state of the second external electronic device 104 may include a first state in which the second external electronic device 104 is available to play audio, and a second state in which the second external electronic device 104 is not available to play audio. For example, the first state of the second external electronic device 104 may indicate that a probability that the second external electronic device 104 will be used to play audio is higher than a probability that the second external electronic device 104 will not be used to play audio, and the second state of the second external electronic device 104 may indicate that the probability that the second external electronic device 104 will be used to play audio is lower than or equal to the probability that the second external electronic device 104 will not be used to play audio. However, the disclosure is not limited thereto. The second state of the second external electronic device 104 will be illustrated and described in greater detail below with reference to FIG. 5.

For example, a state of each of the first external electronic device 103 and the second external electronic device 104 may be indicated by each of the advertising signal and the other advertising signal. For example, the advertising signal may indicate the first state of the first external electronic device 103 or the second state of the first external electronic device 103. For example, the other advertising signal may indicate the first state of the second external electronic device 104 or the second state of the second external electronic device 104.

For example, the control circuitry 210 may obtain and transmit the signal further based on a state of the first external electronic device 103 indicated by the advertising signal and a state of the second external electronic device 104 indicated by the other advertising signal. For example, when the advertising signal indicates the first state of the first external electronic device 103 and the other advertising signal indicates the first state of the second external electronic device 104, the control circuitry 210 may execute operations 403 and 405, or execute operations 403 and 407. For example, when the advertising signal indicates the second state of the first external electronic device 103 and the other advertising signal indicates the first state of the second external electronic device 104, the control circuitry 210 may obtain the signal indicating the attempt of the other connection to be executed prior to the attempt of the connection, independently from the reception strength of the advertising signal and the reception strength of the other advertising signal, and transmit the signal to the one or more other electronic devices 102. For example, when the advertising signal indicates the first state of the first external electronic device 103 and the other advertising signal indicates the second state of the second external electronic device 104, the control circuitry 210 may obtain the signal indicating the attempt of the connection to be executed prior to the attempt of the other connection, independently from the reception strength of the advertising signal and the reception strength of the other advertising signal, and transmit the signal to the one or more other electronic devices 102. The obtaining and transmitting of the signal indicating the attempt of the connection to be executed prior to the attempt of the other connection may be illustrated and described in greater detail below with reference to FIG. 5.

FIG. 5 is a diagram illustrating an example of a state of each of a first external electronic device and a second external electronic device according to various embodiments.

Referring to FIG. 5, as in a state 500, the first external electronic device 103 may display a wallpaper 515 (or an execution screen of a software application) via a display 510 of the first external electronic device 103, and the second external electronic device 104 may display a lock screen 525 (or a screen provided in a low power state (e.g., always on display (AoD) screen)) via a display 520 of the second external electronic device 104. For example, since displaying the wallpaper 515 indicates that a probability that the first external electronic device 103 is being used by a user is relatively high, and displaying the lock screen 525 indicates that a probability that the second external electronic device 104 is not being used by the user is relatively high, the first external electronic device 103 may broadcast the advertising signal indicating the first state of the first external electronic device 103, and the second external electronic device 104 may broadcast the other advertising signal indicating the second state of the second external electronic device 104. The control circuitry 210 may obtain and transmit, based on the advertising signal indicating the first state of the first external electronic device 103 and the other advertising signal indicating the second state of the second external electronic device 104, the signal indicating the attempt of the connection to be executed prior to the attempt of the other connection.

For another example, as a in state 550, a direction toward which the display 510 of the first external electronic device 103 positioned on an external object 560 faces may correspond to a reference direction toward which the ground faces, and a direction toward which the display 520 of the second external electronic device 104 positioned on the external object 560 faces may be opposite to the reference direction toward which the ground faces. For example, in the state 550, the display 510 may be exposed, and the display 520 may be covered. For example, since the display 510 being exposed indicates that a probability that the external electronic device 103 is being used by a user is relatively high, and the display 520 being covered indicates that a probability that the second external electronic device 104 is not being used by the user is relatively high, the first external electronic device 103 may broadcast the advertising signal indicating the first state of the first external electronic device 103, and the second external electronic device 104 may broadcast the other advertising signal indicating the second state of the second external electronic device 104. The control circuitry 210 may obtain and transmit, based on the advertising signal indicating the first state of the first external electronic device 103 and the other advertising signal indicating the second state of the second external electronic device 104, the signal indicating the attempt of the connection to be executed prior to the attempt of the other connection.

Although FIG. 5 illustrates an example in which the electronic device 101 obtains and transmits the signal based on the state of each of the first external electronic device 103 and the second external electronic device 104 identified using the advertising signal and the other advertising signal, the state of each of the first external electronic device 103 and the second external electronic device 104 may be processed in each of the first external electronic device 103 and the second external electronic device 104. For example, in response to receiving a connection request transmitted based on the advertising signal from the one or more other electronic devices 102, the first external electronic device 103 in the second state may induce or guide the other connection, by transmitting, to the one or more other electronic devices 102, a signal indicating that the connection request is rejected. For example, in response to receiving a connection request transmitted based on the other advertising signal from the one or more other electronic devices 102, the second external electronic device 104 in the second state may induce or guide the other connection, by transmitting, to the one or more other electronic devices 102, a signal indicating that the connection request is rejected. However, the disclosure is not limited thereto.

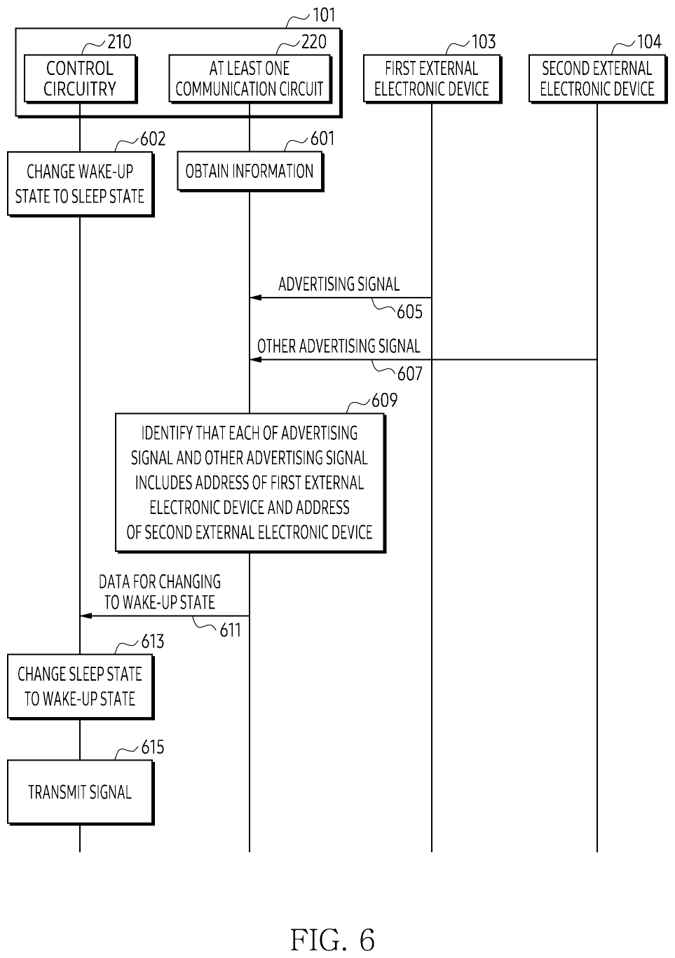

Referring back to FIG. 2, the control circuitry 210 may be in the sleep state (or the low power state) when the advertising signal and the other advertising signal are received. For example, the sleep state of the control circuitry 210 may be changed to the wake-up state, based on an address of the first external electronic device 103 in the advertising signal and an address of the second external electronic device 104 in the other advertising signal. The change from the sleep state to the wake-up state may be illustrated and described in greater detail below with reference to FIG. 6.

FIG. 6 is a signal flow diagram illustrating an example method of changing a state of control circuitry based on an address according to various embodiments.

Referring to FIG. 6, in operation 601, the at least one communication circuit 220 may obtain information.

For example, the information may be transmitted to the electronic device 101 from the one or more other electronic devices 102. For example, the information may be transmitted to the electronic device 101 from the one or more other electronic devices 102 stored in the electronic device 101. For example, the information may be transmitted to the electronic device 101 from the one or more other electronic devices 102, based on a power line communication (PLC) technique. For example, the received information may be obtained by the control circuitry 210. For example, the control circuitry 210 may provide, to the at least one communication circuit 220, the information. For example, the information may be provided to the at least one communication circuit 220 for operation 609. However, the disclosure is not limited thereto.

For example, the information may include an address of the first external electronic device 103 that was connected with the one or more other electronic devices 102 and an address of the second external electronic device 104 that was connected with the one or more other electronic devices 102.

In operation 602, the control circuitry 210 may change the wake-up state to the sleep state. For example, since the electronic device 101 includes a rechargeable battery, the control circuitry 210 may change the wake-up state to the sleep state to reduce power consumption. According to an embodiment, in the sleep state, the at least one communication circuit 220 may maintain an active state (or wake-up state).

For example, the change from the wake-up state to the sleep state may be executed based on usage pattern information usage pattern information of the one or more other electronic devices 102 (and/or usage pattern information of the electronic device 101) received by the electronic device 101 from an external electronic device (e.g., the first external electronic device 103 and/or the second external electronic device 104). For example, the control circuitry 210 may identify that a probability that the electronic device 101 and/or the one or more other electronic devices 102 are used is relatively low, and change, in response to the identification, the wake-up state to the sleep state.

In operation 605, the first external electronic device 103 may broadcast the advertising signal. For example, the advertising signal may be broadcast for discovery of the first external electronic device 103. The at least one communication circuit 220 may receive the advertising signal broadcast from the first external electronic device 103 while the control circuitry 210 is in the sleep state.

In operation 607, the second external electronic device 104 may broadcast the other advertising signal. For example, the other advertising signal may be broadcast for discovery of the second external electronic device 104. The at least one communication circuit 220 may receive the other advertising signal broadcast from the second external electronic device 104 while the control circuitry 210 is in the sleep state.

Although operations 605 and 607 illustrate receiving the advertising signal and the other advertising signal, the at least one communication circuit 220 may receive advertising signals broadcast from external electronic devices, including the first external electronic device 103 and the second external electronic device 104, around the electronic device 101, while the control circuitry 210 is in the sleep state.

In operation 609, the at least one communication circuit 220 may identify, based on the information, that each of the advertising signal and the other advertising signal (among the advertising signals) includes the address of the first external electronic device 103 and the address of the second external electronic device 104, while the control circuitry 210 is in the sleep state. For example, the processor 210 may identify that the address of the first external electronic device 103 in the advertising signal is included in the information, and may identify that the address of the second external electronic device 104 in the other advertising signal is included in the information.

In operation 611, the at least one communication circuit 220 may provide, to the control circuitry 210, data for changing to the wake-up state, in response to the identification in operation 609. The data may be used to change the sleep state of the control circuitry 210 to the wake-up state. The control circuitry 210 may obtain the data from the at least one communication circuit 220.

In operation 613, the control circuitry 210 may change the sleep state to the wake-up state, in response to the data. For example, the control circuitry 210 may identify a reception strength of each of the advertising signal and the other advertising signal, in response to the wake-up state changed from the sleep state.

In operation 615, the control circuitry 210 may transmit, to the one or more other electronic devices 102 via the at least one communication circuit 220 or the power management circuit 230, the signal, based on the reception strength of each of the advertising signal and the other advertising signal. For example, the control circuitry 210 may execute operations 403 and 405. For example, the control circuitry 210 may execute operations 403 and 407.

As described above, the control circuitry 210 may be in the sleep state during at least a portion of a time interval prior to transmitting the signal. For example, the electronic device 101 may reduce power consumed to transmit the signal via the operations illustrated and described with reference to FIG. 6.

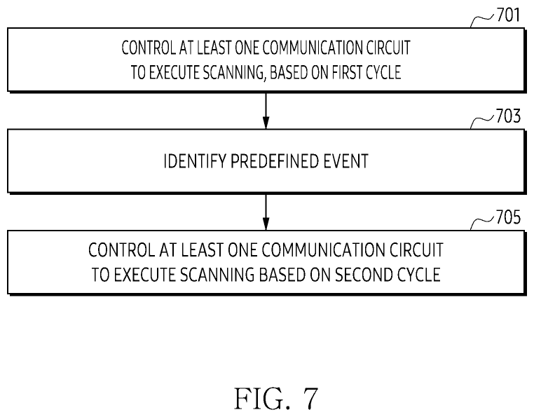

Referring again to FIG. 2, a scanning may be executed to receive the advertising signal and the other advertising signal, via the at least one communication circuit 220. For example, the scanning may include operations for reducing power consumption. The operations may be illustrated and described in greater detail below with reference to FIG. 7.

FIG. 7 is a flowchart illustrating an example method of changing execution of a scanning based on a first cycle to execution of a scanning based on a second cycle according to various embodiments.

Referring to FIG. 7, in operation 701, the control circuitry 210 may control the at least one communication circuit 220 to execute a scanning for receiving advertising signals respectively broadcast from external electronic devices around the electronic device 101 based on a first cycle. For example, the control circuitry 210 may configure the at least one communication circuit 220 to execute the scanning based on the first cycle, independently of whether the control circuitry 210 is in the sleep state or the wake-up state. For example, the scanning executed based on the first cycle may be executed to reduce power consumption.

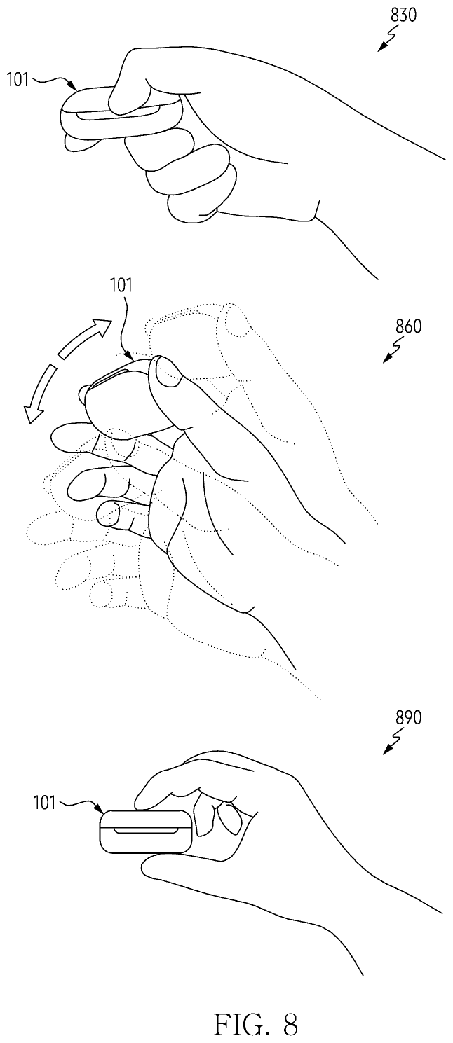

In operation 703, the control circuitry 210 may identify a predefined (e.g., specified) event. The predefined event may be provided to identify whether the one or more other electronic devices 102 stored in the electronic device 101 are in a state available by a user, before a change from the second state of the electronic device 101 to the first state of the electronic device 101. The predefined event may be illustrated and described in greater detail below with reference to FIG. 8.

FIG. 8 is a diagram illustrating an example of a predefined event according to various embodiments.

Referring to FIG. 8, the predefined or specified event may include receiving a touch input within an area provided via a touch sensor included in the at least one sensor 240, as in a state 830. For example, the control circuitry 210 may obtain data indicating points of contact on a portion of the housing of the electronic device 101, and identify a touch input identified based on the data as the predefined event. For example, since the touch input may be a user action performed before changing a state of the electronic device 101 from the second state to the first state, the control circuitry 210 may identify the touch input as the predefined event.

For another example, the predefined event may include identifying a motion of the electronic device 101 corresponding to a reference motion via a motion sensor (e.g., acceleration sensor and/or gyro sensor) included in the at least one sensor 240, as in a state 860. For example, the control circuitry 210 may obtain data indicating a motion (or a change in a motion) of the electronic device 101 via the motion sensor, and identify identifying that the motion (or the change in the motion) of the electronic device 101 indicated by the data corresponds to a reference motion as the predefined event. For example, since the motion (or the change in the motion) corresponding to the reference motion may be a user action performed before changing the state of the electronic device 101 from the second state to the first state, the control circuitry 210 may identify the motion (or the change in the motion) as the predefined event.

For still another example, as in a state 890, the predefined event may include identifying that the electronic device 101 is gripped via a barometer or a grip sensor included in the at least one sensor 240. For example, the control circuitry 210 may obtain data indicating that the electronic device 101 is gripped, via the barometer (or the grip sensor), and identify the grip of the electronic device 101 indicated by the data as the predefined event. For example, since gripping the electronic device 101 may be a user action performed before changing the state of the electronic device 101 from the second state to the first state, the grip of the electronic device 101 may be identified as the predefined event.

Referring back to FIG. 7, in operation 705, the control circuitry 210 may control the at least one communication circuit 220 to execute the scanning based on a second cycle shorter than the first cycle, in response to the predefined event. For example, a size of a window (or scan window) for the scanning executed based on the second cycle may be larger than a size of a window for the scanning executed based on the first cycle. For example, power consumed by the scanning executed based on the second cycle may be greater than power consumed by the scanning executed based on the first cycle, but the scanning executed based on the second cycle may be executed more frequently than the scanning executed based on the first cycle. For example, power consumed by the scanning executed based on the second cycle may be greater than power consumed by the scanning executed based on the first cycle, but a size of the window of the scanning executed based on the second cycle may be greater than a size of the window of the scanning executed based on the first cycle. For example, since time resources used for the scanning executed based on the second cycle are greater than time resources used for the scanning executed based on the first cycle, a probability that the advertising signal and the other advertising signal will be received according to the scanning executed based on the second cycle may be higher than a probability that the advertising signal and the other advertising signal will be received according to the scanning executed based on the first cycle. For example, since identifying the predefined event indicates that a probability that the state of the electronic device 101 is changed to the first state is relatively high, the control circuitry 210 may control the at least one communication circuit 220 to execute the scanning based on the second cycle, in order to enhance performance for receiving the advertising signal and the other advertising signal. For example, the advertising signal and the other advertising signal may be received via the at least one communication circuit 220, based on the scanning executed based on the second cycle (and/or the scanning executed based on the first cycle).

As described above, the electronic device 101 may adaptively change a method of executing the scanning based on the predefined event. For example, the electronic device 101 may reduce power consumption via the adaptive change in the execution of the scanning. For example, the electronic device 101 may provide enhanced performance via the adaptive change in the execution of the scanning.

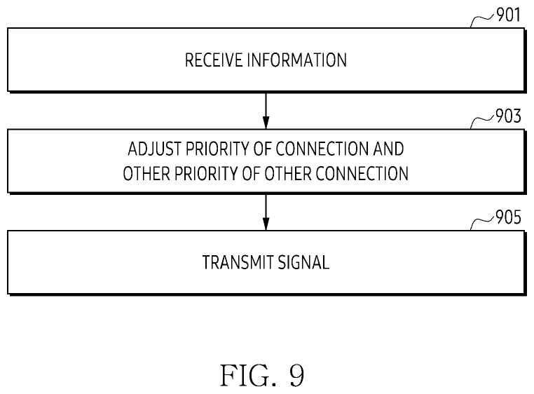

Referring back to FIG. 2, in operation 401, the control circuitry 210 may receive, from the one or more other electronic devices 102, information indicating a priority of the connection between the one or more other electronic devices 102 and the first external electronic device 103 and another priority of the other connection between the one or more other electronic devices 102 and the second external electronic device 104, before the advertising signal and the other advertising signal are received. For example, the control circuitry 210 may obtain, based on adjusting the priority of the connection and the other priority of the other connection indicated by the information, the signal, and transmit, to the one or more other electronic devices 102 via the at least one communication circuit 220 or the power management circuit 230, the signal. Transmitting the signal based on adjusting the priority of the connection and the other priority of the other connection indicated by the information may be illustrated and described in greater detail below with reference to FIG. 9.

FIG. 9 is a flowchart illustrating an example method of transmitting a signal by adjusting a priority of a connection and another priority of another connection based on a reception strength of an advertising signal and a reception strength of another advertising signal according to various embodiments.

Referring to FIG. 9, in operation 901, the control circuitry 210 may receive, from the one or more other electronic devices 102 via the power management circuit 230 or the at least one communication circuit 220, the information. For example, the information may indicate the priority of the connection before the advertising signal is received and the other priority of the other connection before the other advertising signal is received. As a non-limiting example, the other priority of the other connection indicated by the information may be higher than the priority of the connection indicated by the information. For example, when the second external electronic device 104 among the first external electronic device 103 and the second external electronic device 104 is most recently connected with the one or more other electronic devices 102, the other priority of the other connection may be higher than the priority of the connection. For example, when the second external electronic device 104 among the first external electronic device 103 and the second external electronic device 104 is most frequently connected with the one or more other electronic devices 102, the other priority of the other connection may be higher than the priority of the connection.

In operation 903, the control circuitry 210 may adjust the priority of the connection and the other priority of the other connection based on the reception strength of the advertising signal being greater than the reception strength of the other advertising signal. For example, the priority of the connection may be higher than the other priority of the other connection in accordance with the adjustment.

In operation 905, the control circuitry 210 may transmit, to the one or more other electronic devices 102, the signal indicating the attempt of the connection to be executed prior to the attempt of the other connection, by indicating the priority of the connection higher than the other priority of the other connection in accordance with the adjustment.

As described above, the electronic device 101 may receive a list of external electronic devices that was connected with the one or more other electronic devices 102, such as the information in operation 901. For example, the list may include an address of each of the external electronic devices. For example, the list may include a priority of a connection between each of the external electronic devices and the one or more other electronic devices 102. For example, in the list, the priority may be associated with the address. For example, the electronic device 101 may enhance user experience of the one or more other electronic devices 102, by adjusting the priority in the list based on a reception strength of each of advertising signals received by the electronic device 101.

Referring back to FIG. 2, a condition for transmitting the signal may be set variously. For example, the signal may be transmitted to the one or more other electronic devices 102, in response to a result of a comparison between the reception strength of the advertising signal and the reception strength of the other advertising signal. For example, the signal may be transmitted in response to identifying that the priority of the connection and the other priority of the other connection are adjusted. For example, the signal may be transmitted in response to a predefined event. The transmitting the signal in response to the predefined event may be illustrated and described in greater detail below with reference to FIG. 10.

FIG. 10 is a flowchart illustrating an example method of transmitting a signal in response to a predefined event according to various embodiments.

Referring to FIG. 10, in operation 1001, the control circuitry 210 may identify a predefined event. The predefined event may be provided to identify whether a connection between one or more other electronic devices 102 and an external electronic device is required. For example, the predefined event may include identifying that the second state of the electronic device 101 is changed to the first state of the electronic device 101. For example, the predefined event may include a user action performed before the second state of the electronic device 101 is changed to the first state of the electronic device 101. For example, the predefined event may include the operations illustrated through the state 830, the state 860, and/or the state 890 of FIG. 8. However, the disclosure is not limited thereto.

In operation 1003, in response to the predefined event, the control circuitry 210 may transmit, to the one or more other electronic devices 102 via the at least one communication circuit 220 or the power management circuit 230, the signal. For example, the signal may indicate the priority of the connection and the other priority of the other connection, or may indicate the connection to be executed prior to the other connection, or may indicate the other connection to be executed prior to the connection.

As described above, the electronic device 101 may transmit the signal to the one or more other electronic devices 102 in response to the predefined event, such that a connection between the one or more other electronic devices 102 and an external electronic device (e.g., the first external electronic device 103 or the second external electronic device 104) is completed before the one or more other electronic devices 102 are worn by the user.

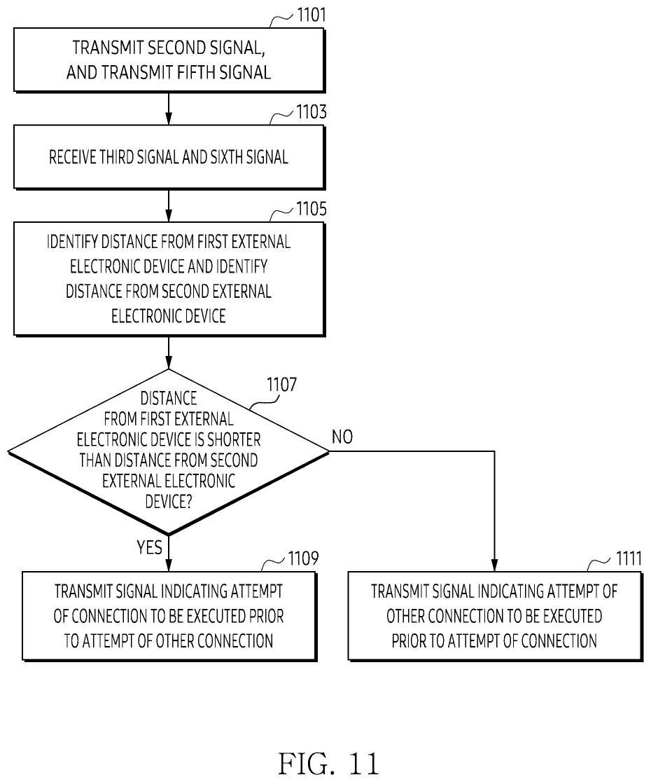

Referring back to FIG. 2, a distance from the first external electronic device 103 and a distance from the second external electronic device 104 may be identified via the second communication circuit within the at least one communication circuit 220. For example, the distance from the first external electronic device 103 and the distance from the second external electronic device 104 may be identified via a UWB communication technique. The identification executed via the UWB communication technique may be illustrated and described in greater detail below with reference to FIG. 11.

FIG. 11 is a flowchart illustrating an example method of transmitting a signal based on a distance from a first external electronic device and a distance from a second external electronic device according to various embodiments.

Referring to FIG. 11, in operation 1101, while the one or more other electronic devices 102 are stored in the housing of the electronic device 101, the control circuitry 210 may transmit, to the first external electronic device 103 via the second communication circuit, a second signal in response to a first signal received from the first external electronic device 103 via the second communication circuit, and may transmit, to the second external electronic device 104 via the second communication circuit, a fifth signal in response to a fourth signal received from the second external electronic device 104 via the second communication circuit. For example, the first signal and the second signal, together with a third signal to be described in greater detail below, may be used to identify the distance from the first external electronic device 103, and the fourth signal and the fifth signal, together with a sixth signal to be described in greater detail below, may be used to identify the distance from the second external electronic device 104.

For example, a reception of the fourth signal and a transmission of the fifth signal may be executed before a reception of the first signal and a transmission of the second signal, may be executed after the reception of the first signal and the transmission of the second signal, or may be executed along with the reception of the first signal and the transmission of the second signal. However, the disclosure is not limited thereto.

In operation 1103, the control circuitry 210 may receive, via the second communication circuit, the third signal transmitted from the first external electronic device 103 in response to the second signal, and may receive, via the second communication circuit, the sixth signal transmitted from the second external electronic device 104 in response to the fifth signal.

For example, a reception of the third signal may be executed before a reception of the sixth signal, may be executed after the reception of the sixth signal, or may be executed along with the reception of the sixth signal. However, the disclosure is not limited thereto.

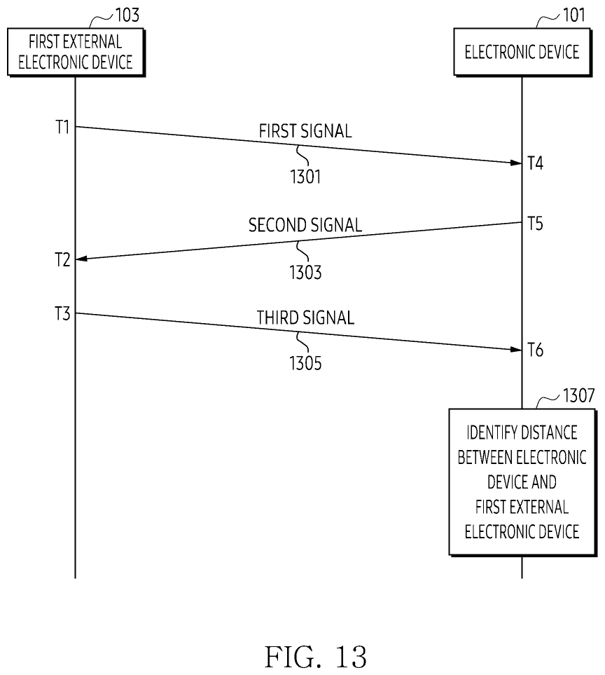

In operation 1105, the control circuitry 210 may identify the distance from the first external electronic device 103 based at least in part on the first signal, the second signal, and the third signal, and may identify the distance from the second external electronic device 104 based at least in part on the fourth signal, the fifth signal, and the sixth signal. For example, the control circuitry 210 may identify the distance from the first external electronic device 103, based on a reception time of the first signal, a transmission time of the second signal, and a reception time of the third signal. For example, the control circuitry 210 may identify the distance from the second external electronic device 104, based on a reception time of the fourth signal, a transmission time of the fifth signal, and a reception time of the sixth signal. A method of identifying the distance from the first external electronic device 103 will be illustrated and described in detail below with reference to FIG. 13.

In operation 1107, the control circuitry 210 may identify whether the distance from the first external electronic device 103 is less than the distance from the second external electronic device 104.

For example, the control circuitry 210 may execute operation 1109 based on the distance from the first external electronic device 103 being less than the distance from the second external electronic device 104, and may execute operation 1111 based on the distance from the first external electronic device 103 being greater than the distance from the second external electronic device 104.

In operation 1109, on a condition that the distance from the first external electronic device 103 is less than the distance from the second external electronic device 104, the control circuitry 210 may transmit, to the one or more other electronic devices 102 via the at least one communication circuit 220 or the power management circuit 230, the signal indicating the attempt of the connection to be executed prior to the attempt of the other connection. The signal may be transmitted via the first communication circuit or the power management circuit 230.

For example, the distance from the first external electronic device 103 being shorter than the distance from the second external electronic device 104 may indicate that the distance from the first external electronic device 103 is shorter than the distance from the second external electronic device 104, and that a difference value between the distance from the first external electronic device 103 and the distance from the second external electronic device 104 is greater than or equal to a reference value. However, the disclosure is not limited thereto.

Although not illustrated in FIG. 11, the one or more other electronic devices 102 may receive the signal from the electronic device 101. For example, based on the signal, the one or more other electronic devices 102 may execute operations for establishing the connection prior to executing operations for establishing the other connection. For example, the operations for establishing the connection may be executed in response to the one or more other electronic devices 102 identifying that the state of the electronic device 101 is changed from the second state to the first state. For example, the operations for establishing the other connection may be executed in response to identifying that establishing the connection has failed.

In operation 1111, on a condition that the distance from the first external electronic device 103 is greater than the distance from the second external electronic device 104, the control circuitry 210 may transmit, to the one or more other electronic devices 102 via the at least one communication circuit 220 or the power management circuit 230, the signal indicating the attempt of the other connection to be executed prior to the attempt of the connection. The signal may be transmitted via the first communication circuit or the power management circuit 230.

For example, the distance from the first external electronic device 103 being greater than the distance from the second external electronic device 104 may indicate that the distance from the first external electronic device 103 is greater than the distance from the second external electronic device 104, and that a difference value between the distance from the first external electronic device 103 and the distance from the second external electronic device 104 is greater than or equal to the reference value. However, the disclosure is not limited thereto.

Although not illustrated in FIG. 11, the one or more other electronic devices 102 may receive the signal from the electronic device 101. For example, the one or more other electronic devices 102 may execute, based on the signal, operations for establishing the other connection prior to executing operations for establishing the connection. For example, the operations for establishing the other connection may be executed in response to the one or more other electronic devices 102 identifying that the state of the electronic device 101 is changed from the second state to the first state. For example, the operations for establishing the connection may be executed in response to identifying that establishing the other connection has failed.

Although not illustrated in FIG. 11, the control circuitry 210 may identify, based on the distance from the first external electronic device 103 corresponding to the distance from the second external electronic device 104, data indicating a history of the connection and a history of the other connection, and may transmit, based on the identified data, the signal indicating the attempt of the connection to be executed prior to the attempt of the other connection or the signal indicating the attempt of the other connection to be executed prior to the attempt of the connection, to the one or more other electronic devices 102 via the at least one communication circuit 220 or the power management circuit 230. For example, the data may be obtained from the one or more other electronic devices 102 stored within the housing of the electronic device 101, before operation 1101 is executed or before the execution of operations 1101 to 1105 is completed. For example, the data may be obtained via a connection (e.g., the connection 140) between the electronic device 101 and the one or more other electronic devices 102.

For example, the distance from the first external electronic device 103 corresponding to the distance from the second external electronic device 104 may indicate that the distance from the first external electronic device 103 is equal to the distance from the second external electronic device 104. The distance from the first external electronic device 103 corresponding to the distance from the second external electronic device 104 may indicate that the distance from the first external electronic device 103 is greater than or less than the distance from the second external electronic device 104, and that a difference value between the distance from the first external electronic device 103 and the distance from the second external electronic device 104 is less than the reference value. However, the disclosure is not limited thereto.

For example, the data used when the reception strength of the advertising signal corresponds to the reception strength of the other advertising signal may indicate an external electronic device most recently connected with the one or more other electronic devices 102 from among the first external electronic device 103 and the second external electronic device 104. For example, when the first external electronic device 103 among the first external electronic device 103 and the second external electronic device 104 is most recently connected with the one or more other electronic devices 102, the signal may indicate, based on the data, the attempt of the connection to be executed prior to the attempt of the other connection. For example, when the second external electronic device 104 among the first external electronic device 103 and the second external electronic device 104 is most recently connected with the one or more other electronic devices 102, the signal may indicate, based on the data, the attempt of the other connection to be executed prior to the attempt of the connection.

For example, the data may indicate an external electronic device most frequently connected with the one or more other electronic devices 102 from among the first external electronic device 103 and the second external electronic device 104. For example, when the first external electronic device 103 among the first external electronic device 103 and the second external electronic device 104 is most frequently connected with the one or more other electronic devices 102, the signal may indicate, based on the data, the attempt of the connection to be executed prior to the attempt of the other connection. For example, when the second external electronic device 104 among the first external electronic device 103 and the second external electronic device 104 is most frequently connected with the one or more other electronic devices 102, the signal may indicate, based on the data, the attempt of the other connection to be executed prior to the attempt of the connection.

As described above, the electronic device 101 may enhance, via the UWB communication technique, responsiveness of the connection of the one or more other electronic devices 102.

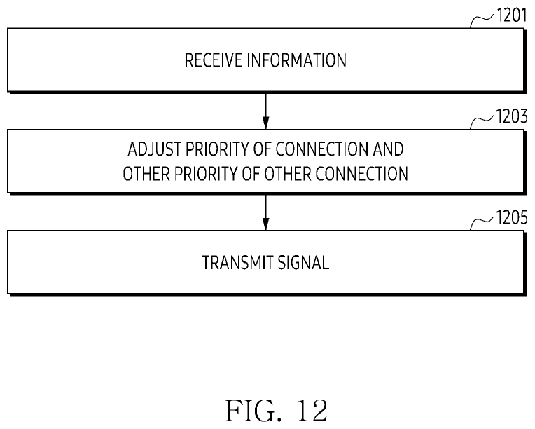

Referring back to FIG. 2, in operation 1101, the control circuitry 210 may receive, from the one or more other electronic devices 102, information indicating a priority of the connection between the one or more other electronic devices 102 and the first external electronic device 103 and another priority of the other connection between the one or more other electronic devices 102 and the second external electronic device 104, before the first signal and the fourth signal are received. For example, the control circuitry 210 may obtain, based on adjusting the priority of the connection and the other priority of the other connection indicated by the information, the signal, and transmit, to the one or more other electronic devices 102 via the at least one communication circuit 220 or the power management circuit 230, the signal. Transmitting the signal to the one or more other electronic devices 102 based on adjusting the priority of the connection and the other priority of the other connection indicated by the information may be illustrated and described in greater detail below with reference to FIG. 12.

FIG. 12 is a flowchart illustrating an example method of transmitting a signal by adjusting a priority of a connection and another priority of another connection based on a distance from a first external electronic device and a distance from a second external electronic device according to various embodiments.

Referring to FIG. 12, in operation 1201, the control circuitry 210 may receive, from the one or more other electronic devices 102 via the power management circuit 230 or the at least one communication circuit 220, the information. For example, the information may indicate the priority of the connection before the first signal is received and the other priority of the other connection before the fourth signal is received. As a non-limiting example, the other priority of the other connection indicated by the information may be higher than the priority of the connection indicated by the information. For example, when the second external electronic device 104 among the first external electronic device 103 and the second external electronic device 104 is most recently connected with the one or more other electronic devices 102, the other priority of the other connection may be higher than the priority of the connection. For example, when the second external electronic device 104 among the first external electronic device 103 and the second external electronic device 104 is most frequently connected with the one or more other electronic devices 102, the other priority of the other connection may be higher than the priority of the connection.

In operation 1203, the control circuitry 210 may adjust, based, for example, on the distance from the second external electronic device 104 being greater than the distance from the first external electronic device 103, the priority of the connection and the other priority of the other connection. For example, the distance from the first external electronic device 103 being less than the distance from the second external electronic device 104 may be identified through operations 1105 and 1107 of FIG. 11.

In operation 1205, the control circuitry 210 may transmit, to the one or more other electronic devices 102, the signal indicating the attempt of the connection to be executed prior to the attempt of the other connection, by indicating the priority of the connection higher than the other priority of the other connection in accordance with the adjustment.

As described above, the electronic device 101 may receive a list of external electronic devices that was connected with the one or more other electronic devices 102, such as the information in operation 1201. For example, the list may include an address of each of the external electronic devices. For example, the list may include a priority of a connection between each of the external electronic devices and the one or more other electronic devices 102. For example, in the list, the priority may be associated with the address. For example, the electronic device 101 may enhance user experience of the one or more other electronic devices 102, by adjusting the priority in the list based on signals (e.g., the first signal to the sixth signal) received and transmitted by the electronic device 101.

For example, the control circuitry 210 may identify the distance from the first external electronic device 103 based on a reception time of the first signal, a transmission time of the second signal, and a reception time of the third signal, and may identify the distance from the second external electronic device 104 based on a reception time of the fourth signal, a transmission time of the fifth signal, and a reception time of the sixth signal. Identifying the distance from the first external electronic device 103 based on the reception time of the first signal, the transmission time of the second signal, and the reception time of the third signal may be illustrated and described in greater detail below with reference to FIG. 13.

FIG. 13 is a signal flow diagram illustrating an example method of identifying a distance from a first external electronic device according to various embodiments.

Referring to FIG. 13, in operation 1301, the first external electronic device 103 may transmit a first signal to the electronic device 101. For example, the first signal may be referred to as a poll message. For example, the first external electronic device 103 may transmit, based on address information of the electronic device 101 recognized within the first external electronic device 103, the first signal. For example, the first external electronic device 103 may record or store a first time T1 at which the first signal is received.

For example, the electronic device 101 may receive the first signal via the second communication circuit. For example, the electronic device 101 may record or store a fourth time T4 at which the first signal is received.

In operation 1303, in response to the first signal, the electronic device 101 may transmit, to the first external electronic device 103 via the second communication circuit, a second signal. For example, the second signal may be a response signal for the first signal. For example, the second signal may be referred to as a response message. For example, the electronic device 101 may record or store a fifth time T5 at which the second signal is transmitted.

For example, the first external electronic device 103 may receive the second signal. For example, the first external electronic device 103 may record or store a second time T2 at which the second signal is received.

In operation 1305, the first external electronic device 103 may transmit a third signal to the electronic device 101, based on the second signal. For example, the third signal may include data about the first time T1, the second time T2, and a third time T3 at which the third signal is transmitted. For example, the first time T1, the second time T2, and the third time T3 may be included in the third signal to identify a distance between the electronic device 101 and the first external electronic device 103.

For example, the electronic device 101 may receive the third signal via the second communication circuit. For example, the electronic device 101 may record or store a sixth time T6 at which the third signal is received.

In operation 1307, in response to the third signal, the electronic device 101 may identify a distance between the electronic device 101 and the first external electronic device 103, based on the first time T1, the second time T2, the third time T3, the fourth time T4, the fifth time T5, and the sixth time T6. For example, the electronic device 101 may identify the distance, based on applying the first time T1, the second time T2, the third time T3, the fourth time T4, the fifth time T5, and the sixth time T6 to Equation 1 below.

$$T o F = [ ( T 2 - T 1 ) - ( T 5 - T 4 ) + ( T 6 - T 5 ) - ( T 3 - T 2 ) ] / 4 \qquad [ Equation 1 ]$$

In Equation 1, a time of flight (ToF) may indicate a time until a signal from the electronic device 101 reaches the first external electronic device 103 (or a time until the signal from the first external electronic device 103 reaches the electronic device 101).

For example, the electronic device 101 may identify a distance from the first external electronic device 103, based on applying a speed of light to the ToF obtained through Equation 1,as in Equation 2 below.

$$D = ToF \times c \qquad [ Equation 2 ]$$

In Equation 2, D indicates the distance, and c may indicate the speed of light.

Although not illustrated in FIG. 13, the electronic device 101 may identify the distance from the second external electronic device 104, by executing signalings of FIG. 13 with the second external electronic device 104.

As described above, the electronic device 101 may assist in identifying an external device to be connected to the one or more other electronic devices 102, based on the distance from the first external electronic device 103 and the distance from the second external electronic device 104.

FIG. 14 is a block diagram illustrating an example electronic device 1401 in a network environment 1400 according to various embodiments. Referring to FIG. 14, the electronic device 1401 in the network environment 1400 may communicate with an electronic device 1402 via a first network 1498 (e.g., a short-range wireless communication network), or at least one of an electronic device 1404 or a server 1408 via a second network 1499 (e.g., a long-range wireless communication network). According to an embodiment, the electronic device 1401 may communicate with the electronic device 1404 via the server 1408. According to an embodiment, the electronic device 1401 may include a processor 1420, memory 1430, an input module 1450, a sound output module 1455, a display module 1460, an audio module 1470, a sensor module 1476, an interface 1477, a connecting terminal 1478, a haptic module 1479, a camera module 1480, a power management module 1488, a battery 1489, a communication module 1490, a subscriber identification module (SIM) 1496, or an antenna module 1497. In various embodiments, at least one of the components (e.g., the connecting terminal 1478) may be omitted from the electronic device 1401, or one or more other components may be added in the electronic device 1401. In various embodiments, some of the components (e.g., the sensor module 1476, the camera module 1480, or the antenna module 1497) may be implemented as a single component (e.g., the display module 1460).

The processor 1420 may execute, for example, software (e.g., a program 1440) to control at least one other component (e.g., a hardware or software component) of the electronic device 1401 coupled with the processor 1420, and may perform various data processing or computation. According to an embodiment, as at least part of the data processing or computation, the processor 1420 may store a command or data received from another component (e.g., the sensor module 1476 or the communication module 1490) in volatile memory 1432, process the command or the data stored in the volatile memory 1432, and store resulting data in non-volatile memory 1434. According to an embodiment, the processor 1420 may include a main processor 1421 (e.g., a central processing unit (CPU) or an application processor (AP)), or an auxiliary processor 1423 (e.g., a graphics processing unit (GPU), a neural processing unit (NPU), an image signal processor (ISP), a sensor hub processor, or a communication processor (CP)) that is operable independently from, or in conjunction with, the main processor 1421. For example, when the electronic device 1401 includes the main processor 1421 and the auxiliary processor 1423, the auxiliary processor 1423 may be adapted to consume less power than the main processor 1421, or to be specific to a specified function. The auxiliary processor 1423 may be implemented as separate from, or as part of the main processor 1421. Thus, the processor 1420 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1423 may control at least some of functions or states related to at least one component (e.g., the display module 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). According to an embodiment, the auxiliary processor 1423 (e.g., an image signal processor or a communication processor) may be implemented as part of another component (e.g., the camera module 1480 or the communication module 1490) functionally related to the auxiliary processor 1423. According to an embodiment, the auxiliary processor 1423 (e.g., the neural processing unit) may include a hardware structure specified for artificial intelligence model processing. An artificial intelligence model may be generated by machine learning. Such learning may be performed, e.g., by the electronic device 1401 where the artificial intelligence is performed or via a separate server (e.g., the server 1408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1430 may store various data used by at least one component (e.g., the processor 1420 or the sensor module 1476) of the electronic device 1401. The various data may include, for example, software (e.g., the program 1440) and input data or output data for a command related thereto. The memory 1430 may include the volatile memory 1432 or the non-volatile memory 1434.

The program 1440 may be stored in the memory 1430 as software, and may include, for example, an operating system (OS) 1442, middleware 1444, or an application 1446.

The input module 1450 may receive a command or data to be used by another component (e.g., the processor 1420) of the electronic device 1401, from the outside (e.g., a user) of the electronic device 1401. The input module 1450 may include, for example, a microphone, a mouse, a keyboard, a key (e.g., a button), or a digital pen (e.g., a stylus pen).

The sound output module 1455 may output sound signals to the outside of the electronic device 1401. The sound output module 1455 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1460 may visually provide information to the outside (e.g., a user) of the electronic device 1401. The display module 1460 may include, for example, a display, a hologram device, or a projector and control circuitry to control a corresponding one of the display, hologram device, and projector. According to an embodiment, the display module 1460 may include a touch sensor adapted to detect a touch, or a pressure sensor adapted to measure the intensity of force incurred by the touch.

The audio module 1470 may convert a sound into an electrical signal and vice versa. According to an embodiment, the audio module 1470 may obtain the sound via the input module 1450, or output the sound via the sound output module 1455 or a headphone of an external electronic device (e.g., an electronic device 1402) directly (e.g., wiredly) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. According to an embodiment, the sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device (e.g., the electronic device 1402) directly (e.g., wiredly) or wirelessly. According to an embodiment, the interface 1477 may include, for example, a high definition multimedia interface (HDMI), a universal serial bus (USB) interface, a secure digital (SD) card interface, or an audio interface.

A connecting terminal 1478 may include a connector via which the electronic device 1401 may be physically connected with the external electronic device (e.g., the electronic device 1402). According to an embodiment, the connecting terminal 1478 may include, for example, an HDMI connector, a USB connector, a SD card connector, or an audio connector (e.g., a headphone connector).

The haptic module 1479 may convert an electrical signal into a mechanical stimulus (e.g., a vibration or a movement) or electrical stimulus which may be recognized by a user via his tactile sensation or kinesthetic sensation. According to an embodiment, the haptic module 1479 may include, for example, a motor, a piezoelectric element, or an electric stimulator.

The camera module 1480 may capture a still image or moving images. According to an embodiment, the camera module 1480 may include one or more lenses, image sensors, image signal processors, or flashes.

The power management module 1488 may manage power supplied to the electronic device 1401. According to an embodiment, the power management module 1488 may be implemented as at least part of, for example, a power management integrated circuit (PMIC).

The battery 1489 may supply power to at least one component of the electronic device 1401. According to an embodiment, the battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the application processor (AP)) and supports a direct (e.g., wired) communication or a wireless communication. According to an embodiment, the communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as Bluetooth™, wireless-fidelity (Wi-Fi) direct, or infrared data association (IrDA)) or the second network 1499 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The wireless communication module 1492 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1492 may support a high-frequency band (e.g., the mmWave band) to achieve, e.g., a high data transmission rate. The wireless communication module 1492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1492 may support various requirements specified in the electronic device 1401, an external electronic device (e.g., the electronic device 1404), or a network system (e.g., the second network 1499). According to an embodiment, the wireless communication module 1492 may support a peak data rate (e.g., 20 Gbps or more) for implementing eMBB, loss coverage (e.g., 1464 dB or less) for implementing mMTC, or U-plane latency (e.g., 0.5 ms or less for each of downlink (DL) and uplink (UL), or a round trip of 14 ms or less) for implementing URLLC.

The antenna module 1497 may transmit or receive a signal or power to or from the outside (e.g., the external electronic device) of the electronic device 1401. According to an embodiment, the antenna module 1497 may include an antenna including a radiating element including a conductive material or a conductive pattern formed in or on a substrate (e.g., a printed circuit board (PCB)). According to an embodiment, the antenna module 1497 may include a plurality of antennas (e.g., array antennas). In such a case, at least one antenna appropriate for a communication scheme used in the communication network, such as the first network 1498 or the second network 1499, may be selected, for example, by the communication module 1490 (e.g., the wireless communication module 1492) from the plurality of antennas. The signal or the power may then be transmitted or received between the communication module 1490 and the external electronic device via the selected at least one antenna. According to an embodiment, another component (e.g., a radio frequency integrated circuit (RFIC)) other than the radiating element may be additionally formed as part of the antenna module 1497.

According to various embodiments, the antenna module 1497 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1401 and the external electronic device 1404 via the server 1408 coupled with the second network 1499. Each of the electronic devices 1402 or 1404 may be a device of a same type as, or a different type, from the electronic device 1401. According to an embodiment, all or some of operations to be executed at the electronic device 1401 may be executed at one or more of the external electronic devices 1402, 1404, or 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1401. The electronic device 1401 may provide the outcome, with or without further processing of the outcome, as at least part of a reply to the request. To that end, a cloud computing, distributed computing, mobile edge computing (MEC), or client-server computing technology may be used, for example. The electronic device 1401 may provide ultra low-latency services using, e.g., distributed computing or mobile edge computing. In an embodiment, the external electronic device 1404 may include an internet-of-things (IoT) device. The server 1408 may be an intelligent server using machine learning and/or a neural network. According to an embodiment, the external electronic device 1404 or the server 1408 may be included in the second network 1499. The electronic device 1401 may be applied to intelligent services (e.g., smart home, smart city, smart car, or healthcare) based on 5G communication technology or IoT-related technology.

As described above, according to an example embodiment, an electronic device may comprise: a housing, at least one communication circuit disposed in the housing, a power management circuit disposed in the housing, and configured to charge a rechargeable battery of one or more other electronic devices stored in a portion of the housing, and control circuitry disposed in the housing, operably coupled with the at least one communication circuit and the power management circuit. According to an example embodiment, the control circuitry may be configured to cause the electronic device to: while the one or more other electronic devices are stored in the housing, identify receiving an advertising signal broadcast from a first external electronic device and another advertising signal broadcast from a second external electronic device; and based on a reception strength of the advertising signal being greater than a reception strength of the other advertising signal, transmit, to the one or more other electronic devices, a signal indicating an attempt of a connection between the first external electronic device and the one or more other electronic devices to be executed prior to an attempt of another connection between the second external electronic device and the one or more other electronic devices.

According to an example embodiment, the control circuitry may be configured to cause the electronic device to: receive information including an address of the first external electronic device that was connected with the one or more other electronic devices before the advertising signal is received, and an address of the second external electronic device that was connected with the one or more other electronic devices before the other advertising signal is received. According to an example embodiment, the at least one communication circuit may be configured to, while the control circuitry is in a sleep state, receive advertising signals respectively broadcast from external electronic devices around the electronic device. According to an example embodiment, the at least one communication circuit may be configured to, while the control circuitry is in the sleep state, based on the information, identify that the advertising signal from among the advertising signals includes the address of the first external electronic device in the information and the other advertising signal from among the advertising signals includes the address of the second external electronic device in the information, respectively. According to an example embodiment, the at least one communication circuit may be configured to, in response to identifying that the advertising includes the address of the first external electronic device in the information and the other advertising signal includes the address of the second external electronic device 104 in the information, provide, to the control circuitry, data for changing from the sleep state to a wake-up state. According to an example embodiment, the control circuitry may be configured to, in response to the wake-up state being changed from the sleep state in response to the data, based on the reception strength of the advertising signal and the reception strength of the other advertising signal, transmit, to the one or more other electronic devices, the signal.

According to an example embodiment, the control circuitry may be configured to, based on a first cycle, control the at least one communication circuit to execute a scanning for receiving advertising signals respectively broadcast from external electronic devices around the electronic device. According to an example embodiment, the control circuitry may be configured to, in response to a specified event, based on a second cycle shorter than the first cycle, control the at least one communication circuit to execute the scanning. According to an example embodiment, a size of a window for the scanning executed based on the first cycle may be less than a size of a window for the scanning executed based on the second cycle. According to an example embodiment, the advertising signal and the other advertising signal may be received via the at least one communication circuit based at least in part on the scanning executed based on the first cycle and the scanning executed based on the second cycle.

According to an example embodiment, the electronic device may further comprise at least one sensor. According to an example embodiment, the control circuitry may be configured to, based on data obtained via the at least one sensor, identify the specified event. According to an example embodiment, the at least one sensor may comprise a touch sensor. According to an example embodiment, the control circuitry may be configured to obtain data indicating points of contact on a portion of the housing, via the touch sensor. According to an example embodiment, the control circuitry may be configured to identify a touch input identified based on the data as the predefined event.

According to an example embodiment, the at least one sensor may comprise a motion sensor. According to an example embodiment, the control circuitry may be configured to obtain data indicating a motion of the electronic device, via the motion sensor. According to an example embodiment, the control circuitry may be configured to identify the motion corresponding to a reference motion as the specified event.

According to an example embodiment, the at least one sensor may comprise a barometer. According to an example embodiment, the control circuitry may be configured to obtain data indicating that the electronic device is gripped, via the barometer. According to an example embodiment, the control circuitry may be configured to identify the grip of the electronic device indicated by the data as the specified event.

According to an example embodiment, the control circuitry may be configured to, before the advertising signal and the other advertising signal are received, receive information indicating a priority of the connection and another priority of the other connection higher than the priority of the connection. According to an example embodiment, the control circuitry may be configured to, based on the reception strength of the advertising signal being greater than the reception strength of the other advertising signal, adjust, in the information, the priority of the connection and the other priority of the other connection.

According to an example embodiment, the control circuitry may be configured to transmit, to the one or more other electronic devices, the signal indicating the attempt of the connection to be executed prior to the attempt of the other connection by indicating the priority of the connection higher than the other priority of the other connection in accordance with the adjustment.

According to an example embodiment, the signal may be, in response to identifying that the reception strength of the advertising signal is greater than the reception strength of the other advertising signal, transmitted to the one or more other electronic devices. According to an example embodiment, the signal may be, in response to identifying a predefined event after identifying that the reception strength of the advertising signal is greater than the reception strength of the other advertising signal, transmitted to the one or more other electronic devices.

According to an example embodiment, the specified event may be identified based on data obtained via the at least one sensor of the electronic device.

According to an example embodiment, each of the advertising signal and the other advertising signal may indicate a state of each of the first external electronic device and the second external electronic device. According to an example embodiment, the signal may be transmitted further based on the state.

As described above, according to an example embodiment, an electronic device may comprise: a housing, a first communication circuit disposed in the housing and a second communication circuit disposed in the housing, a power management circuit disposed in the housing, and configured to charge a rechargeable battery of one or more other electronic devices stored in a portion of the housing, and control circuitry in the housing. According to an example embodiment, the control circuitry may be configured to control the electronic device to: while the one or more other electronic devices are stored in the housing, identify, via the second communication circuit, a distance from the first external electronic device and a distance from the second external electronic device. According to an example embodiment, the control circuitry may be configured to identify, based at least in part on a first signal, a second signal, and a third signal, a distance from the first external electronic device. According to an example embodiment, the control circuitry may be configured to identify, based at least in part on a fourth signal, a fifth signal, and a sixth signal, a distance from the second external electronic device. According to an example embodiment, the control circuitry may be configured to, based on the distance from the second external electronic device being greater than the distance from the first external electronic device, transmit, to the one or more other electronic devices, via the power management circuit or the second communication circuit, a signal indicating an attempt of a connection between the first external electronic device and the one or more other electronic devices to be executed prior to an attempt of another connection between the second external electronic device and the one or more other electronic devices.

According to an example embodiment, the control circuitry may be configured to, before the distance from the first external electronic device and the distance from the second external electronic device are identified, receive, from the one or more other electronic devices, via the power management circuit or the second communication circuit, information indicating a priority of the connection and another priority of the other connection higher than the priority of the connection. According to an example embodiment, the control circuitry may be configured to, based on the distance from the second external electronic device being greater than the distance from the first external electronic device, adjust, in the information, the priority of the connection and the other priority of the other connection. According to an example embodiment, the control circuitry may be configured to cause the electronic device to transmit, to the one or more other electronic devices, the signal indicating the attempt of the connection to be executed prior to the attempt of the other connection, by indicating the priority of the connection higher than the other priority of the other connection in accordance with the adjustment.

According to an example embodiment, the control circuitry may be configured to, in response to a first signal received via the second communication circuit from a first external electronic device, cause the electronic device to transmit, to the first external electronic device via the second communication circuit, a second signal, while the one or more other electronic devices are stored in the housing. According to an example embodiment, the control circuitry may be configured to, in response to a fourth signal received via the second communication circuit from a second external electronic device, cause the electronic device to transmit, to the second external electronic device via the second communication circuit, a fifth signal, while the one or more other electronic devices are stored in the housing. According to an example embodiment, the control circuitry may be configured to cause the electronic device to receive, in response to the second signal, a third signal transmitted from the first external electronic device via the second communication circuit and receive, in response to the fifth signal, a sixth signal transmitted from the second external electronic device via the second communication circuit. According to an example embodiment, the control circuitry may be configured to identify, based at least in part on the first signal, the second signal, and the third signal, the distance from the first external electronic device and identify, based at least in part on the fourth signal, the fifth signal, and the sixth signal, the distance from the second external electronic device.

As described above, according to an example embodiment, a method may be executed in an electronic device comprising: a housing, at least one communication circuit disposed in the housing, and a power management circuit disposed in the housing, and configured to charge a rechargeable battery of one or more other electronic devices stored in a portion of the housing. According to an example embodiment, the method may comprise: while the one or more other electronic devices are stored in the housing, identifying receiving an advertising signal broadcast from a first external electronic device and another advertising signal broadcast from a second external electronic device. According to an example embodiment, the method may comprise, based on a reception strength of the advertising signal being greater than a reception strength of the other advertising signal, transmitting, to the one or more other electronic devices, a signal indicating an attempt of a connection between the first external electronic device and the one or more other electronic devices to be executed prior to an attempt of another connection between the second external electronic device and the one or more other electronic devices.

According to an example embodiment, the method may comprise, based on a first cycle, controlling the at least one communication circuit to execute a scanning for receiving advertising signals respectively broadcast from external electronic devices around the electronic device. According to an example embodiment, the method may comprise, in response to a specified event, based on a second cycle shorter than the first cycle, controlling the at least one communication circuit to execute the scanning. According to an example embodiment, a size of a window for the scanning executed based on the first cycle may be smaller than a size of a window for the scanning executed based on the second cycle. According to an example embodiment, the advertising signal and the other advertising signal may be received via the at least one communication circuit based at least in part on the scanning executed based on the first cycle and the scanning executed based on the second cycle.

According to an example embodiment, the specified event may be identified based on data obtained via at least one sensor of the electronic device.

According to an example embodiment, the method may comprise, before the advertising signal and the other advertising signal are received, receiving, from the one or more other electronic devices, via the power management circuit and/or the at least one communication circuit, information indicating a priority of the connection and another priority of the other connection higher than the priority of the connection. According to an example embodiment, the transmitting the signal may comprise, based on the reception strength of the advertising signal being greater than the reception strength of the other advertising signal, adjusting, in the information, the priority of the connection and the other priority of the other connection. According to an example embodiment, the transmitting the signal may comprise, transmitting, to the one or more other electronic devices, the signal indicating the attempt of the connection to be executed prior to the attempt of the other connection by indicating the priority of the connection higher than the other priority of the other connection in accordance with the adjustment.

According to an example embodiment, each of the advertising signal and the other advertising signal may indicate a state of each of the first external electronic device and the second external electronic device. According to an example embodiment, the signal may be transmitted further based on the state.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a housing;
at least one communication circuit disposed in the housing;
a power management circuit disposed in the housing, and configured to charge a rechargeable battery of one or more other electronic devices stored in a portion of the housing; and
control circuitry disposed in the housing, and configured to cause the electronic device to:
while the one or more other electronic devices are stored in the housing, identify receiving an advertising signal broadcast from a first external electronic device and another advertising signal broadcast from a second external electronic device; and
based on a reception strength of the advertising signal being greater than a reception strength of the other advertising signal, transmit, to the one or more other electronic devices, a signal indicating an attempt of a connection between the first external electronic device and the one or more other electronic devices to be executed prior to an attempt of another connection between the second external electronic device and the one or more other electronic devices.

2. The electronic device of claim 1, wherein the control circuitry is configured to cause the electronic device to:
receive information including:
an address of the first external electronic device that was connected with the one or more other electronic devices before the advertising signal is received, and
an address of the second external electronic device that was connected with the one or more other electronic devices before the other advertising signal is received,
wherein the at least one communication circuit is configured to cause the electronic device to:
while the control circuitry is in a sleep state, receive advertising signals respectively broadcast from external electronic devices within a specified distance of the electronic device;
while the control circuitry is in the sleep state, based on the information, identify that the advertising signal from among the advertising signals includes the address of the first external electronic device in the information and the other advertising signal from among the advertising signals includes the address of the second external electronic device in the information;
in response to identifying that the advertising includes the address of the first external electronic device in the information and the other advertising signal includes the address of the second external electronic device in the information, provide, to the control circuitry, data for changing from the sleep state to a wake-up state, and
wherein the control circuitry is configured to cause the electronic device to:
in response to the wake-up state being changed from the sleep state in response to the data, based on the reception strength of the advertising signal and the reception strength of the other advertising signal, transmit, to the one or more other electronic devices, the signal.

3. The electronic device of claim 1, wherein the control circuitry is configured to cause the electronic device to:
based on a first cycle, control the at least one communication circuit to execute a scanning for receiving advertising signals respectively broadcast from external electronic devices around the electronic device; and
in response to a specified event, based on a second cycle shorter than the first cycle, control the at least one communication circuit to execute the scanning,
wherein a size of a window for the scanning executed based on the first cycle is smaller than a size of a window for the scanning executed based on the second cycle, and
wherein the advertising signal and the other advertising signal are configured to be received via the at least one communication circuit based at least in part on the scanning executed based on the first cycle and the scanning executed based on the second cycle.

4. The electronic device of claim 3, further comprising:
at least one sensor,
wherein the control circuitry is configured to, based on data obtained via the at least one sensor, identify the specified event.

5. The electronic device of claim 4, wherein the at least one sensor comprises a touch sensor, and
wherein the control circuitry is configured to:
obtain data indicating points of contact on a portion of the housing, via the touch sensor; and
identify a touch input identified based on the data as the specified event.

6. The electronic device of claim 4, wherein the at least one sensor comprises a motion sensor, and
wherein the control circuitry is configured to:
obtain data indicating a motion of the electronic device, via the motion sensor; and
identify the motion corresponding to a reference motion as the specified event.

7. The electronic device of claim 4, wherein the at least one sensor comprises a barometer, and
wherein the control circuitry is configured to:
obtain data indicating that the electronic device is gripped, via the barometer; and
identify the grip of the electronic device indicated by the data as the specified event.

8. The electronic device of claim 1, wherein the control circuitry is configured to cause the electronic device to:
before the advertising signal and the other advertising signal are received, receive information indicating a priority of the connection and another priority of the other connection higher than the priority of the connection;
based on the reception strength of the advertising signal being greater than the reception strength of the other advertising signal, adjust, in the information, the priority of the connection and the other priority of the other connection; and
transmit, to the one or more other electronic devices, the signal indicating the attempt of the connection to be executed prior to the attempt of the other connection by indicating the priority of the connection higher than the other priority of the other connection in accordance with the adjustment.

9. The electronic device of claim 1, wherein the signal, in response to identifying that the reception strength of the advertising signal is greater than the reception strength of the other advertising signal, is transmitted to the one or more other electronic devices.

10. The electronic device of claim 1, wherein the signal, in response to identifying a specified event after identifying that the reception strength of the advertising signal is greater than the reception strength of the other advertising signal, is transmitted to the one or more other electronic devices.

11. The electronic device of claim 10, wherein the specified event is identified based on data obtained via the at least one sensor of the electronic device.

12. The electronic device of claim 1, wherein each of the advertising signal and the other advertising signal indicates a state of each of the first external electronic device and the second external electronic device, and
wherein the signal is transmitted further based on the state.

13. An electronic device comprising:
a housing;
first communication circuitry disposed in the housing;
second communication circuitry disposed in the housing;
power management circuitry disposed in the housing, and configured to charge a rechargeable battery of one or more other electronic devices stored in a portion of the housing; and
control circuitry disposed in the housing,
wherein the control circuitry is configured to cause the electronic device to:
while the one or more other electronic devices are stored in the housing, identify, via the second communication circuitry, a distance from the first external electronic device and a distance from the second external electronic device;
identify, based at least in part on a first signal, a second signal, and a third signal, a distance from the first external electronic device;
identify, based at least in part on a fourth signal, a fifth signal, and a sixth signal, a distance from the second external electronic device;
based on the distance from the second external electronic device being greater than the distance from the first external electronic device, transmit, to the one or more other electronic devices, via the power management circuitry and/or the second communication circuitry, a signal indicating an attempt of a connection between the first external electronic device and the one or more other electronic devices to be executed prior to an attempt of another connection between the second external electronic device and the one or more other electronic devices.

14. The electronic device of claim 13, wherein the control circuitry is configured to cause the electronic device to:
before the distance from the first external electronic device and the distance from the second external electronic device are identified, receive, from the one or more other electronic devices, via the power management circuitry and/or the second communication circuitry, information indicating a priority of the connection and another priority of the other connection higher than the priority of the connection;
based on the distance from the second external electronic device being greater than the distance from the first external electronic device, adjust, in the information, the priority of the connection and the other priority of the other connection; and
transmit, to the one or more other electronic devices, the signal indicating the attempt of the connection to be executed prior to the attempt of the other connection, by indicating the priority of the connection higher than the other priority of the other connection in accordance with the adjustment.

15. The electronic device of claim 13, wherein the control circuitry is configured to cause the electronic device to:
in response to a first signal received via the second communication circuitry from a first external electronic device, transmit, to the first external electronic device via the second communication circuitry, a second signal, while the one or more other electronic devices are stored in the housing;
in response to a fourth signal received via the second communication circuitry from a second external electronic device, transmit, to the second external electronic device via the second communication circuitry, a fifth signal, while the one or more other electronic devices are stored in the housing;
receive, in response to the second signal, a third signal transmitted from the first external electronic device via the second communication circuitry and receive, in response to the fifth signal, a sixth signal transmitted from the second external electronic device via the second communication circuitry; and
identify, based at least in part on the first signal, the second signal, and the third signal, the distance from the first external electronic device and identify, based at least in part on the fourth signal, the fifth signal, and the sixth signal, the distance from the second external electronic device.

16. A method executed in an electronic device comprising a housing, at least one communication circuit disposed in the housing, and a power management circuit disposed in the housing, and configured to charge a rechargeable battery of one or more other electronic devices stored in a portion of the housing, the method comprising:
while the one or more other electronic devices are stored in the housing, identifying receiving an advertising signal broadcast from a first external electronic device and another advertising signal broadcast from a second external electronic device; and
based on a reception strength of the advertising signal being greater than a reception strength of the other advertising signal, transmitting, to the one or more other electronic devices, a signal indicating an attempt of a connection between the first external electronic device and the one or more other electronic devices to be executed prior to an attempt of another connection between the second external electronic device and the one or more other electronic devices.

17. The method of claim 16, further comprising:
based on a first cycle, controlling the at least one communication circuit to execute a scanning for receiving advertising signals respectively broadcast from external electronic devices around the electronic device; and
in response to a specified event, based on a second cycle shorter than the first cycle, controlling the at least one communication circuit to execute the scanning,
wherein a size of a window for the scanning executed based on the first cycle is smaller than a size of a window for the scanning executed based on the second cycle, and
wherein the advertising signal and the other advertising signal are received via the at least one communication circuit based at least in part on the scanning executed based on the first cycle and the scanning executed based on the second cycle.

18. The method of claim 17, wherein the specified event is identified based on data obtained via at least one sensor of the electronic device.

19. The method of claim 16, comprising:
before the advertising signal and the other advertising signal are received, receiving, from the one or more other electronic devices, via the power management circuitry and/or the at least one communication circuit, information indicating a priority of the connection and another priority of the other connection higher than the priority of the connection,
wherein the transmitting the signal comprises, based on the reception strength of the advertising signal being greater than the reception strength of the other advertising signal, adjusting, in the information, the priority of the connection and the other priority of the other connection, and
wherein the transmitting the signal comprises, transmitting, to the one or more other electronic devices, the signal indicating the attempt of the connection to be executed prior to the attempt of the other connection by indicating the priority of the connection higher than the other priority of the other connection in accordance with the adjustment.

20. The method of claim 16, wherein each of the advertising signal and the other advertising signal indicate a state of each of the first external electronic device and the second external electronic device, and
wherein the signal is transmitted further based on the state.
